(19) United States
(12) Patent Application Publication
(10) Pub. No.: US 2025/0097982 A1
(43) Pub. Date: Mar. 20, 2025

(54) RACH CONSIDERATIONS UNDER BEAM BASED SSB POWER FOR NETWORK ENERGY SAVING

(71) Applicant: QUALCOMM Incorporated, San Diego, CA (US)

(72) Inventors: Ahmed Attia ABOTABL, San Diego, CA (US); Diana MAAMARI, San Diego, CA (US); Navid ABEDINI, Basking Ridge, NJ (US)

(21) Appl. No.: 18/468,495

(22) Filed: Sep. 15, 2023

(51) Int. Cl. H04W 74/08; H04B 7/06; H04B 17/318; H04W 72/044

(52) U.S. Cl. CPC H04W 74/0833; H04B 7/0626; H04B 17/328; H04W 72/046

(57) ABSTRACT

This disclosure provides methods, components, devices, and systems for enhancing the efficiency of random access channel (RACH) processes in wireless communication networks using beam-specific configurations. Some aspects more specifically relate to the utilization of beam-specific RACH parameters, such as synchronization signal block (SSB) reference signal received power (RSRP) thresholds, two-step RACH parameters, two-step RACH thresholds, physical uplink shared channel (PUSCH) RSRP thresholds, supplementary uplink (SUL) RSRP thresholds, and channel state information reference signal (CSI-RS) RSRP thresholds, to optimize RACH processes. In some examples, a UE obtains a beam-specific configuration including one or more of these beam-specific RACH parameters and a downlink reference signal from a network entity, and sends to the network entity a RACH message associated with the downlink reference signal based on the parameters. The beam-specific configuration considers the unique characteristics and conditions of each transmission beam direction, resulting in improved network energy savings and resource allocation.

### TECHNICAL FIELD

The present disclosure relates to wireless communication, and more particularly, to beam-specific configurations for enhancing the efficiency of random access channel (RACH) processes in wireless communication networks.

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain a configuration including one or more beam-specific random access channel (RACH) parameters, the one or more beam-specific RACH parameters including at least one of: a plurality of synchronization signal block (SSB) reference signal received power (RSRP) thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a physical uplink shared channel (PUSCH) RSRP threshold for PUSCH transmission repetitions in four-step random access, a supplementary uplink (SUL) RSRP threshold for selection between a normal uplink (NUL) carrier and a SUL carrier for random access, or a channel state information reference signal (CSI-RS) RSRP threshold for selection of a CSI-RS for four-step random access. The one or more processors, individually or in any combination, are also operable to cause the apparatus to obtain a downlink reference signal from a network entity, and to send to the network entity a RACH message associated with the downlink reference signal based on the one or more beam-specific RACH parameters.

Another innovative aspect of the subject matter described in this disclosure may be implemented in a method of wireless communication performable at a UE. The method includes obtaining a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The method further includes obtaining a downlink reference signal from a network entity, and sending to the network entity a RACH message associated with the downlink reference signal based on the one or more beam-specific RACH parameters.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to send a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The one or more processors, individually or in any combination, are also operable to cause the apparatus to send a downlink reference signal to a UE, and obtain from the UE a RACH message associated with the downlink reference signal based on the one or more beam-specific RACH parameters.

Another innovative aspect of the subject matter described in this disclosure may be implemented in a method of wireless communication performable at a network entity. The method includes sending a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The method further includes sending a downlink reference signal to a UE, and obtaining from the UE a RACH message associated with the downlink reference signal based on the one or more beam-specific RACH parameters.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIGS. 4A-4B are diagrams illustrating examples of beam-independent and beam-specific broadcast configurations of synchronization signal block (SSB) reference signal received power (RSRP) thresholds for random access channel (RACH) transmissions, respectively.

FIG. 5 is a diagram illustrating an example of a multiple RACH transmission scenario.

FIG. 6 is a diagram illustrating an example of part of a two-step RACH process.

FIGS. 7A-7B are diagrams illustrating an example aspect of a beam-specific configuration intended to enhance the efficiency of multiple RACH transmissions.

FIG. 8 is a diagram illustrating example aspects of a beam-specific configuration intended to enhance the efficiency of a two-step RACH process.

FIG. 9 is a diagram illustrating further example aspects of beam-specific configurations to enhance the efficiency of RACH processes.

FIG. 10 is a call flow diagram between a UE and a base station.

FIG. 11 is a flowchart of a method of wireless communication performable at a UE.

FIG. 12 is a flowchart of a method of wireless communication performable at a network entity.

FIG. 13 is a diagram illustrating an example of a hardware implementation for an example apparatus.

FIG. 14 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the subject matter described in this disclosure relate to wireless communication and more particularly to beam-specific configurations for enhancing the efficiency of random access channel (RACH) processes in wireless communication networks. Some aspects more specifically relate to the utilization of beam-specific RACH parameters, such as synchronization signal block (SSB) reference signal received power (RSRP) thresholds, two-step RACH parameters, two-step RACH thresholds, physical uplink shared channel (PUSCH) RSRP thresholds, supplementary uplink (SUL) RSRP thresholds, and channel state information reference signal (CSI-RS) RSRP thresholds, to address inefficiencies of beam-independent RACH processes. In various examples, a UE obtains a beam-specific configuration including one or more of these beam-specific RACH parameters and a downlink reference signal from a network entity, and sends to the network entity a RACH message associated with the downlink reference signal based on the parameters. The beam-specific RACH parameters or RACH message may consider the unique characteristics and conditions of each transmission beam direction, thereby optimizing the RACH process and resulting in improved network energy savings.

In some examples, the beam-specific configuration may include multiple RSRP threshold values for selection of SSBs for four-step random access and respectively associated with different SSB transmission beams. In some examples, the beam-specific configuration may include a two-step RACH parameter in system information indicating whether or not two-step random access is allowed in association with different SSB transmission beams. In some examples, the beam-specific configuration may include multiple two-step RACH thresholds that are beam-specific for selecting an SSB for two-step random access or for selecting between two-step random access and four-step random access, where these thresholds are respectively associated with different SSB transmission beams. In some examples, the beam-specific configuration may include multiple message 3 RSRP thresholds for determining whether to perform PUSCH transmission repetitions in four-step random access and respectively associated with different SSB transmission beams. In some examples, the beam-specific configuration may include multiple SUL SSB RSRP thresholds for selecting between a SUL carrier or a NUL carrier for a preamble transmission and respectively associated with different SSB transmission beams. In some examples, the beam-specific configuration may include multiple CSI-RS RSRP thresholds for selection of a CSI-RS for CSI-RS-based contention-free random access (CFRA) and respectively associated with different CSI-RS transmission beams. In some examples, SSBs may be mapped to RACH occasions (ROs) based on one or more of the aforementioned beam-specific configurations.

Thus, by utilizing beam-specific RACH parameters, the efficiency of RACH processes may be optimized to consider the varying power requirements and load levels of different transmission beams. This may lead to improved network energy savings, better resource allocation, and enhanced performance in both two-step and four-step RACH processes. For instance, first, improved RACH process efficiency may be achieved through the configuration of beam-specific RSRP threshold values for SSB selection. Second, flexible optimization of load and latency across different SSB transmission beams may be achieved through configuration of beam-specific, two-step RACH parameters in system information. Third, increased flexibility may also be achieved in determining appropriate two-step random access or selection between two-step and four-step random access based on beam-specific, two-step RACH thresholds. Fourth, improved PUSCH transmission repetitions in four-step random access may be achieved based on beam-specific message 3 RSRP thresholds. Fifth, more efficient resource allocation for SUL carrier or NUL carrier selection may be achieved based on beam-specific SUL RSRP thresholds. Sixth, increased flexibility in determining appropriate CFRA for each beam may be achieved based on beam-specific CSI-RS RSRP thresholds. Seventh, effective management of resource allocation of ROs for SSBs may be achieved based on SSB-to-RO mappings considering any of the aforementioned beam-specific configurations. Thus, the flexibility provided by the aforementioned beam-specific configurations allows wireless communication networks to adapt to different scenarios and requirements, ultimately contributing to a more sustainable future for wireless communication technologies.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

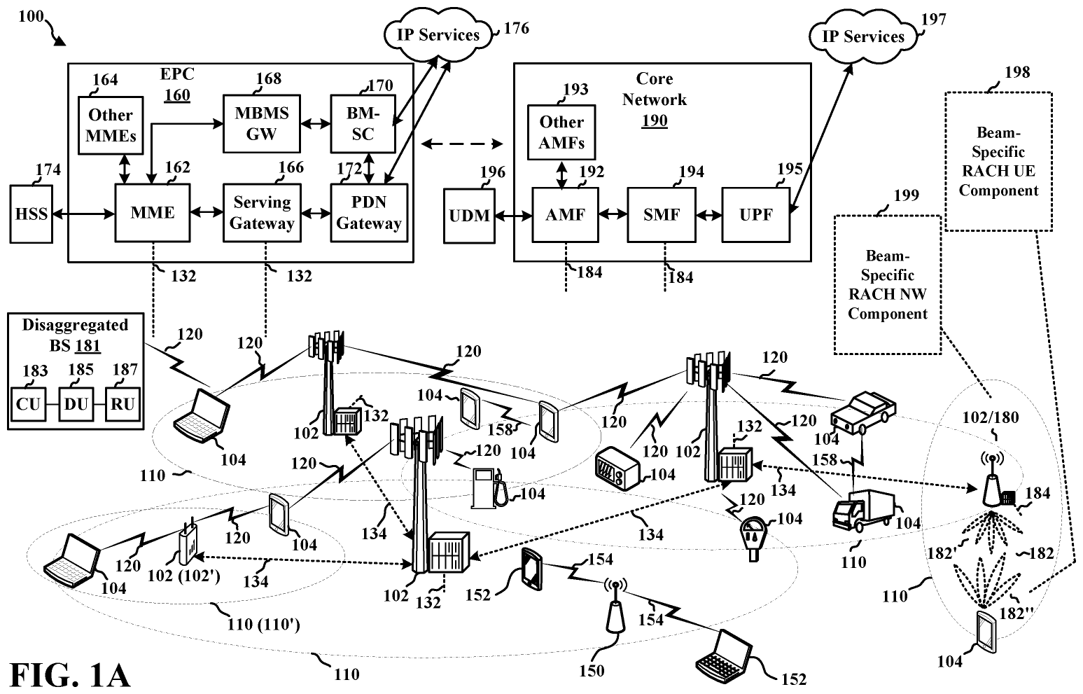

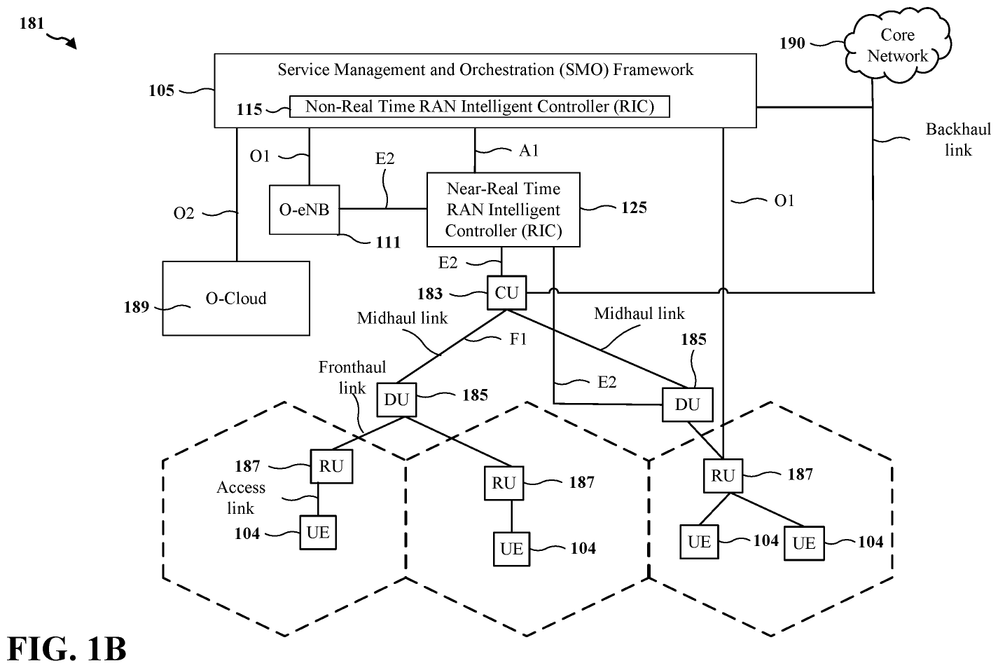

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUS 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-eNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a beam-specific RACH UE component 198 that is configured to obtain a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The beam-specific RACH UE component 198 is further configured to obtain a downlink reference signal from a network entity, and to send to the network entity a RACH message associated with the downlink reference signal based on the one or more beam-specific RACH parameters.

Furthermore, in certain aspects, a network entity such as base station 102/180, disaggregated base station 181, or a component of disaggregated base station 181 such as CU 183, DU 185, or RU 187, may include a beam-specific RACH network (NW) component 199 that is configured to send a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The beam-specific RACH NW component 199 is further configured to send a downlink reference signal to a UE, and to obtain from the UE a RACH message associated with the downlink reference signal based on the one or more beam-specific RACH parameters.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

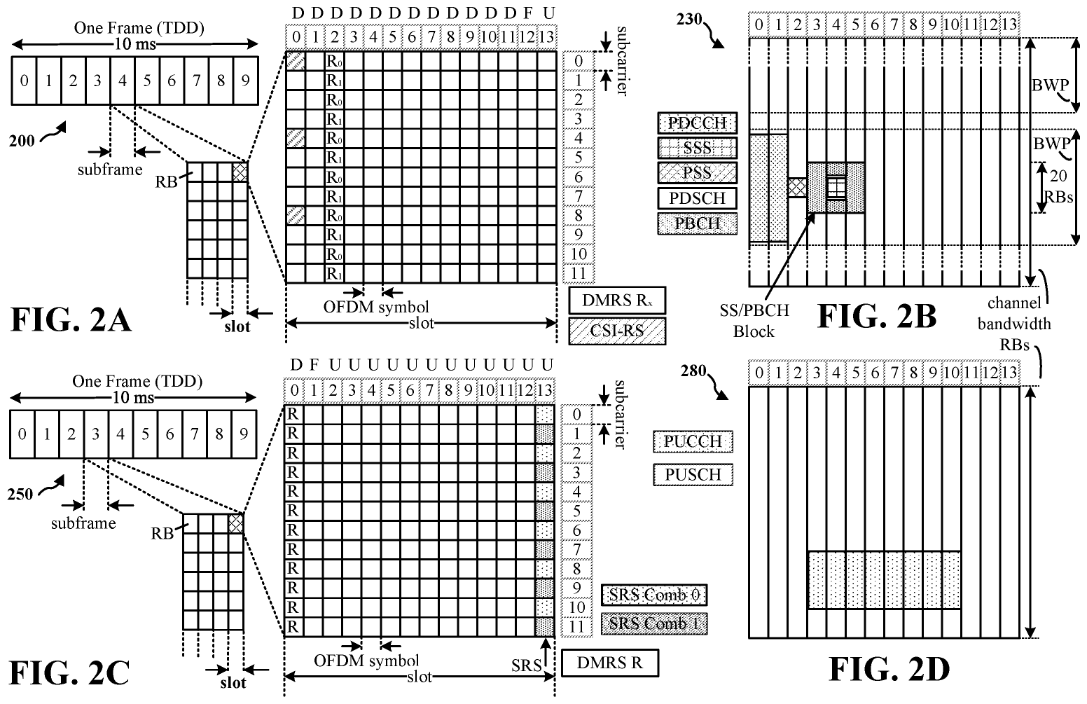

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 24 slots/subframe. The subcarrier spacing and symbol length/duration are a function of the numerology. The subcarrier spacing may be equal to 2^{μ}*15 kilohertz (kHz), where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

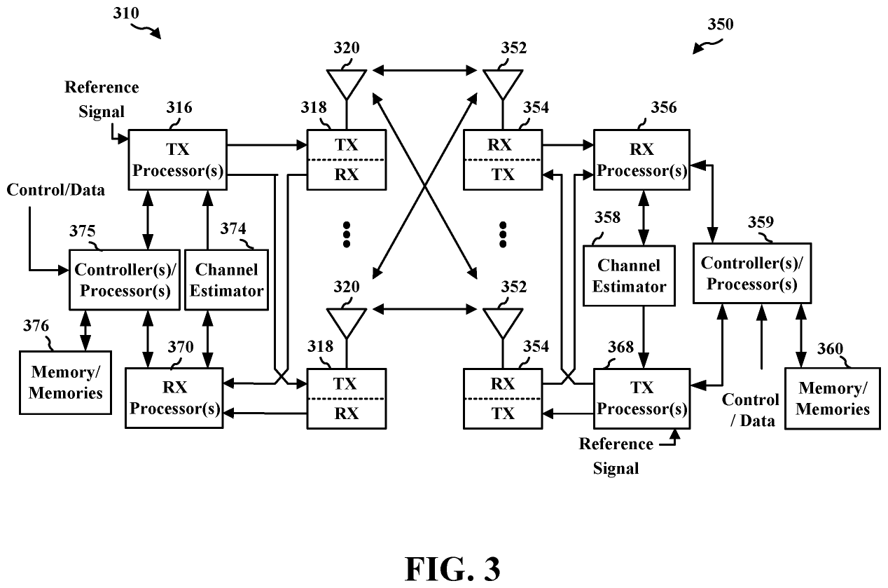

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium. In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium. In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with beam-specific RACH UE component 198 of FIG. 1A.

At least one of the one or more TX processors 316, the one or more RX processors 370, and the one or more controller/processors 375 may be configured to perform aspects in connection with beam-specific RACH NW component 199 of FIG. 1A.

Network energy saving has become a significant aspect of wireless communication technology, particularly with the advent of 5G and the anticipated development of 6G. As 5G deployments are quite power consuming, energy saving measures have been considered to motivate adoption of NR technology. Moreover, network energy saving measures are expected to play an even more significant role in the development and deployment of 6G networks. Recognizing the importance of network energy saving for NR, studies have been performed which focus on specific strategies to enhance energy efficiency in wireless communication networks, in attempt to move towards a more sustainable future for 5G and future technologies. For example, some strategies that have been considered to enhance network power savings include dynamic antenna or power adaptation, cell DTX or cell DRX operation, and beam-specific broadcast configurations.

In regard to beam-specific broadcast configurations, these configurations are intended to allow the network to adapt its transmission power per beam so that network power savings may be achieved through non-uniform spatial coverage. As an example, a base station may semi-statically configure to UEs a beam-specific, SSB power configuration which applies different transmission powers or RSRP thresholds for SSBs transmitted in different directions. For instance, the base station may configure different values per beam of a transmission power parameter (such as ss-PBCH-BlockPower) or an SSB RSRP threshold parameter (such as rsrp-ThresholdSSB) in a RACH configuration, such that the base station applies more SSB power in a beam directed towards a more UE-dense environment such as a building but applies less SSB power in a beam directed towards a less UE-dense environment such as a lake. Such configuration may achieve network energy savings by allowing the base station to semi-statically adapt its SSB transmission power over different beams.

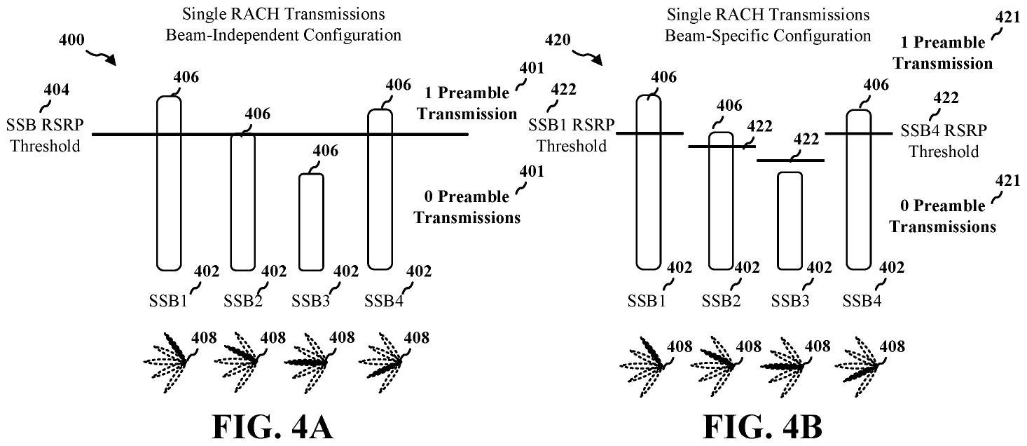

FIGS. 4A and 4B illustrate examples 400, 420 of beam-independent and beam-specific broadcast configurations of SSB RSRP thresholds for RACH transmissions, respectively. In either of these examples, the UE performs a single RACH preamble transmission 401, 421 in a four-step RACH process. For example, the UE may send a single transmission including a RACH preamble associated with a particular SSB before waiting to receive a RAR from the base station. In a four-step RACH process, the UE transmits a RACH preamble (message 1) to a base station, the base station transmits a random access response (RAR) (message 2) in response to the RACH preamble, the UE transmits a PUSCH message (message 3) in response to the RAR, and the base station transmits a contention resolution message (message 4) in response to the PUSCH message.

With respect to example 400 of FIG. 4A, generally following reception of system information or signaling from a base station including SSBs 402 and an SSB RSRP threshold 404, a UE measures RSRPs 406 of the SSBs 402, compares the measured RSRPs 406 to the SSB RSRP threshold 404, and if at least one of these measured RSRPs 406 of an SSB meets or exceeds the SSB RSRP threshold 404, the UE may initiate a 4-step RACH process using a preamble associated with that SSB 402. For instance, in the example of FIG. 4A, the UE may determine that SSB1, SSB2, and SSB4 meet or exceed the SSB RSRP threshold 404 and thus may send a single transmission including a preamble associated with one of these SSBs during 4-step random access. On the other hand, if a measured RSRP of an SSB does not meet or exceed the SSB RSRP threshold 404, such as illustrated in this example 400 with SSB3, the UE may not transmit any preamble associated with that SSB. This SSB RSRP threshold 404 is applied to each SSB 402 regardless or independent of whatever transmission beam 408 is applied for the SSB 402.

In contrast with respect to example 420 of FIG. 4B, if the base station applies a beam-specific power configuration for SSBs 402 rather than the beam-independent configuration of FIG. 4A, the base station may indicate in the system information a single SSB RSRP threshold 422 for each transmission beam 408 of an SSB. Based on such configuration, the UE may receive SSBs 402 over different beams 408 respectively with a different power level and an individual SSB RSRP threshold, and the UE may compare each measured RSRP 406 of an SSB with its associated SSB RSRP threshold 422 to determine the preamble for initiating a 4-step RACH process.

Yet, while beam-specific broadcast configurations such as described with respect to FIG. 4B may result in network energy savings over beam-independent broadcast configurations in single RACH transmission scenarios or four-step RACH processes, it is currently unclear how these beam-specific broadcast configurations may be extended to multiple RACH transmission scenarios or impact two-step RACH processes. Here, multiple RACH transmission scenarios refer to scenarios where the UE sends a RACH preamble in multiple transmissions before waiting to receive a RAR (message 2) from a base station. Two-step RACH processes refer to processes in which the UE transmits the RACH preamble (message 1) and the PUSCH message (message 3) in a combined message (message A) in resources that may be indicated in system information, in response to which message the base station transmits the RAR (message 2) and the contention resolution message (message 4) in a combined message (message B).

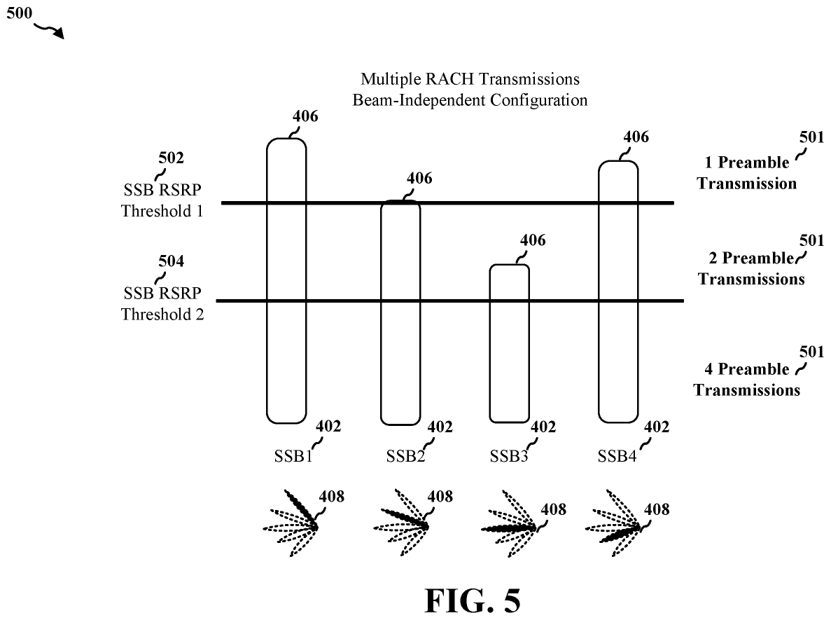

FIG. 5 illustrate an example 500 of a multiple RACH transmission scenario. Here, rather than sending single transmission 401 including a preamble associated with a given SSB as described with respect to FIGS. 4A-4B in a single RACH transmission scenario, in this example the UE may send multiple transmissions 501 including a preamble associated with the SSB 402 in different RACH occasions. Applying multiple repetitions of a preamble transmission associated with a given SSB may improve RACH detection at the base station, particularly in cases when the channel between the UE and the base station is not optimal.

The number of preamble transmissions or repetitions by the UE for a particular SSB depends on the RSRP 406 measured from the SSB 402. For example, if the RSRP 406 is high, the UE may be configured to send one preamble transmission 501 which the base station may successfully decode, while if the RSRP 406 is low, the UE may be configured to send multiple preamble transmissions 501 to improve preamble detectability at the base station. To determine the appropriate number of preamble transmission repetitions to send to the base station, UEs may be configured with more than one SSB RSRP threshold 502, 504 for a given SSB, which threshold may allow the measured RSRP 406 to be categorized as either high, low, or anywhere in between. For example, a UE may determine to send one preamble transmission 501 if the measured RSRP 406 of a particular SSB meets or exceeds a high SSB RSRP threshold 502 for that SSB 402, two preamble transmissions 501 if the measured RSRP 406 of that SSB 402 meets or exceeds a low SSB RSRP threshold 504 but does not meet or exceed the high RSRP threshold 502, or four preamble transmissions 501 if the measured RSRP 406 of the SSB 402 does not meet or exceed the low SSB RSRP threshold 504. The UE may send other numbers of preamble transmission repetitions based on the number of SSB RSRP thresholds 502, 504 and the measured RSRP 406 relative to SSB RSRP thresholds 502, 504 in other examples.

However, while configurations of multiple SSB RSRP thresholds such as described with respect to FIG. 5 may improve RACH detectability at the base station through multiple preamble transmissions, these configurations do not distinguish the number of preamble transmission repetitions between different beams 408 associated with the SSBs 402. For instance, in the example of FIG. 5, the multiple SSB RSRP thresholds 502, 504 of an SSB that are associated with different numbers of RACH preamble transmissions 501 are configured without regard to or independently of whatever transmission beam 408 is applied to that SSB 402. Such beam-independent configurations fail to consider that different transmission beams 408 may be associated with different coverage requirements or otherwise have non-uniform characteristics which may apply to preambles associated with SSBs of different beams 408, resulting in inefficiencies in the RACH process.

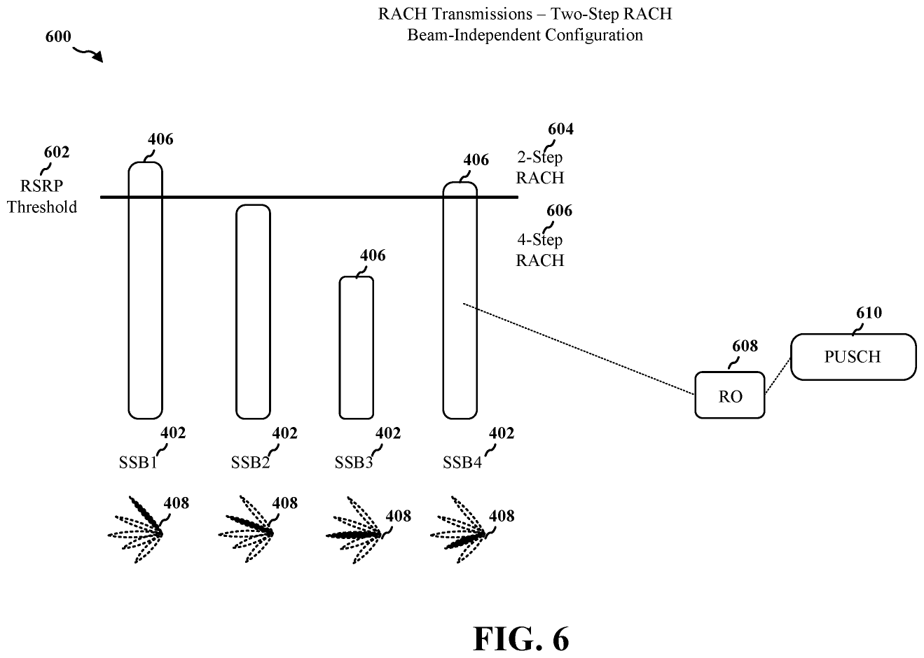

FIG. 6 illustrates an example 600 of part of a two-step RACH process. Initially, a UE determines a preamble associated with an SSB based on its measured RSRP 406 meeting or exceeding an RSRP threshold 602 for selection between two-step random access 604 and four-step random access 606, in addition to meeting or exceeding an SSB RSRP threshold similar to SSB RSRP threshold 404 of FIG. 4A. Then in a two-step RACH process, the UE combines this preamble (message 1) and a PUSCH transmission (message 3) to result in a combined message (message A). For transmitting message A, the base station may configure system information indicating a RACH occasion (RO 608) associated with this SSB 402, and the UE may determine the time and frequency resources of a corresponding PUSCH occasion 610 based on the configured RO 608 and a configured time and frequency offset. The UE may transmit message A in the configured RO 608 and corresponding PUSCH occasion 610 to the base station without waiting for a RAR in message 2, saving resources and reducing latency over 4-step RACH procedures. After receiving message A, the base station may transmit message B to the UE to complete the two-step RACH procedure.

However, when the base station configures and the UE determines ROs 608 and corresponding PUSCH occasions 610 for message A in the system information, the base station and UE do not differentiate between different transmission beams 408 for associated SSBs 402. For example, in current configurations, the base station configures and the UE determines the ROs 608 and corresponding PUSCH occasions 610 associated with SSBs 402 without regard to, or independently of, whatever transmission beam 408 is applied for the associated SSB 402 of that RO 608 or PUSCH occasion 610. Such beam-independent configurations may not be optimal for different beam directions since different load levels in various directions may have different optimization requirements. For example, if lower traffic demands exist in certain directions, configuring ROs 608 or PUSCH occasions 610 in association with those directions may be unnecessary. Similarly, if high traffic demands exist in those directions, configuring ROs 608 or PUSCH occasions 610 in association with those directions may result in reduced performance due to potential congestion. Thus, a uniform approach to configuring these occasions 608, 610 for two-step RACH messaging regardless of SSB direction, or even for performing two-step RACH processes in general, may not be suitable for all scenarios.

Accordingly, aspects of the present disclosure provide several approaches or considerations to extend beam-specific broadcast configurations to multiple RACH transmission scenarios such as illustrated in FIG. 5 and two-step RACH processes such as illustrated in FIG. 6, as well as to enhance the efficiency of four-step RACH processes such as illustrated in FIGS. 4A-4B. For instance, in a first aspect, multiple RSRP threshold values for each SSB transmission beam may be configured in association with multiple RACH preamble transmissions. In a second aspect, a two-step RACH parameter may be provided to indicate whether two-step random access is allowed or not in association with each particular beam carrying an SSB. In a third aspect, one or more RSRP thresholds for selecting an SSB for two-step random access or for selecting between two-step random access and four-step random access may be configured to be beam-specific. In a fourth aspect, a message 3 RSRP threshold for determining whether to perform PUSCH transmission repetitions in four-step random access may be configured to be beam-specific. In a fifth aspect, a SUL SSB RSRP threshold may be configured to be beam-specific. In a sixth aspect, a CSI-RS RSRP threshold for selection of a CSI-RS for CFRA may be configured to be beam-specific. Finally, in a seventh aspect, SSBs may be mapped to ROs based on one or more of the beam-specific configurations. Through one or more of these aspects, the efficiency of RACH processes may be improved.

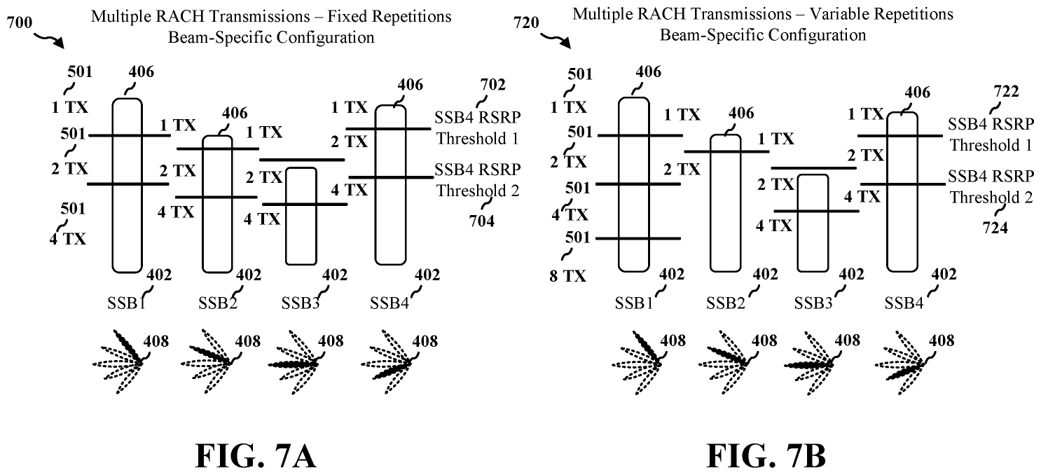

FIGS. 7A-7B illustrate examples 700, 720 of a first aspect of a beam-specific configuration intended to enhance the efficiency of multiple RACH transmissions. In this aspect, the base station may configure multiple RSRP threshold values for each SSB transmission beam 408 in association with multiple RACH preamble transmissions 501. While these example specifically illustrates specific numbers of RSRP thresholds per SSB and specific quantities of preamble transmission repetitions based on measured RSRPs 406, the number of RSRP thresholds configured per SSB and the quantities of preamble transmission repetitions based on measured RSRP 406 may be different in other examples.

Referring to example 700 of FIG. 7A, the base station may provide the UE a SIB that contains or defines values of multiple RSRP thresholds 702, 704 for respective SSBs 402, which the UE may apply to determine the number of preamble transmissions 501 or repetitions to send based on the measured RSRP 406 of a respective SSB. For instance, as illustrated in FIG. 7A, the base station may indicate a different pair of SSB RSRP thresholds 702, 704 for each transmission beam 408 associated with a given SSB, and based on these thresholds 702, 704 in a similar manner to that described with respect to FIG. 5, the UE may determine whether to transmit one, two, or four preamble transmission repetitions according to the measured RSRP 406 of the SSB 402 relative to the thresholds 702, 704 associated with that SSB 402. However, rather than configuring multiple threshold values which are beam-independent as described with respect to FIG. 5, here the base station may indicate the RSRP thresholds 702, 704 per beam 408, and instead of defining a single RSRP threshold per beam for single RACH transmission scenarios such as illustrated in FIG. 4B, here multiple RSRP thresholds per beam may be indicated to extend to multiple RACH transmission scenarios. Thus, this approach may consider the varying power requirements of different beams 408 while providing a more flexible and efficient configuration for RACH processes than beam-independent configurations in multiple RACH transmission scenarios.

With respect to example 720 of FIG. 7B, here the base station may similarly provide a SIB indicating multiple RSRP thresholds 722, 724 for respective SSBs 402, which the UE may likewise apply to determine the number of preamble transmissions 501 or repetitions to send based on the measured RSRP 406 of a respective SSB. However in this example, in addition to indicating multiple SSB RSRP thresholds 722, 724 per beam 408 in the system information, here the base station may further indicate the allowed number of preamble transmissions 501 or repetitions per beam 408 in the system information. That is, rather than configuring a fixed or uniform number of multiple RSRP thresholds 722, 724 or RACH preamble repetitions uniformly across all beams 408 such as illustrated in FIG. 7A, in this example the SIB may indicate different numbers of thresholds 722, 724 or preamble transmissions 501 non-uniformly for different beams 408. For instance, in the fixed repetition example of FIG. 7A, the base station may configure the SIB to uniformly indicate that each beam 408 of an SSB may be associated with two respective thresholds corresponding to one, two, or four repetitions. In contrast, in the variable repetition example of FIG. 7B, the SIB may non-uniformly indicate that one beam 408 may be associated with three thresholds corresponding to one, two, four, and eight repetitions (SIB1 in FIG. 7B), other beams 408 may be associated with two thresholds corresponding to one, two, and four repetitions (SSB3 and SSB4 in FIG. 7B), and another beam 408 may be associated with one threshold corresponding to one or two repetitions (SSB2 in FIG. 7B). Alternatively or additionally, the base station may indicate in the system information that one or more of the beams 408 may only support a single RACH preamble transmission, while other(s) of the beams 408 may be associated with multiple RACH preamble transmissions. For instance, in the illustrated example of FIG. 7B, rather than indicating that the beam 408 associated with SSB2 is associated with one threshold based on which the UE may perform either one or two repetitions of preamble transmissions 501, here the SIB may instead indicate the UE to perform only one transmission if the RSRP 406 exceeds the RSRP threshold and not to perform any preamble transmissions associated with that SSB if the RSRP falls below the threshold. Thus, this approach may provide an even more flexible configuration for RACH processes than the fixed configuration of FIG. 7A while similarly enhancing the efficiency of RACH processes in multiple RACH transmission scenarios.

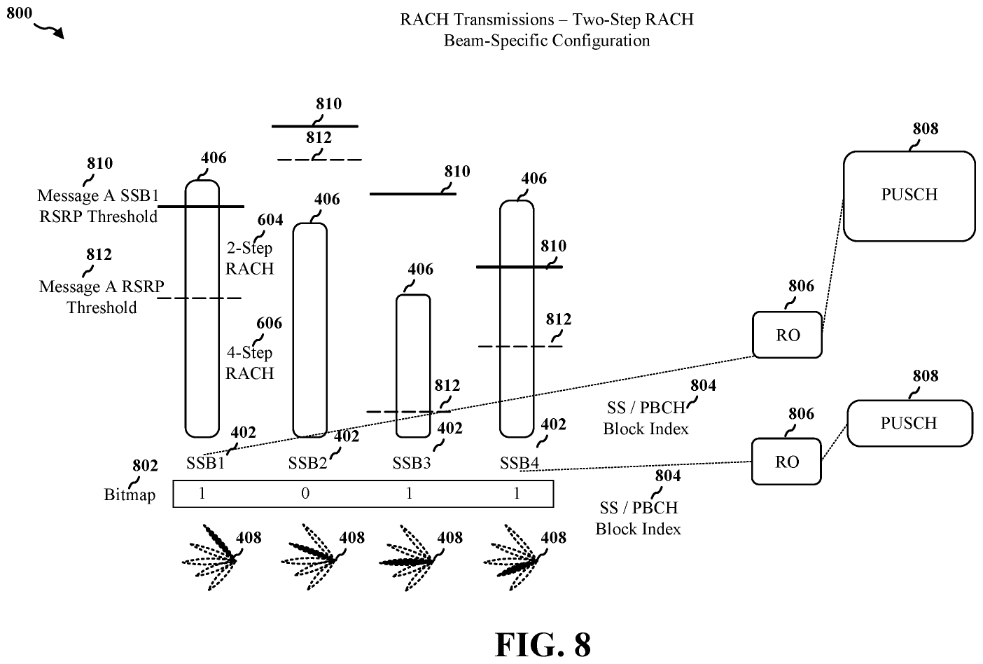

FIG. 8 illustrates an example 800 of a second and third aspect of a beam-specific configuration intended to enhance the efficiency of a two-step RACH process. In the second aspect, the base station may indicate in system information whether two-step random access 604 is allowed or not in association with each particular beam 408 carrying an SSB. For example, this indication may be in the form of a bitmap 802 that specifies whether 2-step RACH is permitted for each SSB 402 or transmission beam 408, where a ‘1’ indicates that the UE is permitted or enabled to perform two-step random access 604 (as well as four-step random access) in association with the corresponding SSB 402, while a ‘0’ indicates that UE is restricted to performing four-step random access 606 in association with the corresponding SSB 402, or vice-versa. Alternatively, rather than indicating whether or not two-step RACH is enabled for a particular SSB via bitmap 802, the base station may provide this indication via a different parameter, such as an identifier of that SSB 402. For instance, the indication may be in the form of a set of SSB identifiers, such as a synchronization signal (SS)/physical broadcast channel (PBCH) index or SSB index 804, where the SSB index 804 of a particular SSB is included in the set if the UE is enabled to perform two-step random access 604 and omitted from the set if the UE is restricted to performing four-step random access 606. How ever this indication is provided, If the bitmap 802, set of SSB identifiers, or other parameter indicates two-step RACH is allowed for a given SSB, the UE may transmit message A in an RO 806 and corresponding PUSCH occasion 808 associated with that SSB 402, while if the bitmap 802, set of SSB identifiers, or other parameter indicates only four-step RACH is allowed for a given SSB, the UE may not transmit a combined message A in association with that SSB 402 but may still transmit a preamble associated with that SSB in message 1 and a corresponding PUSCH in message 3 according to four-step random access. For instance, in the illustrated example of FIG. 8, the UE may determine from bitmap 802 that SSB1, SSB3, and SSB4 are enabled for two-step random access 604, and thus that the UE may obtain preambles associated with those SSBs for inclusion in message A, while the UE may determine from bitmap 802 that SSB2 is disabled from two-step random access 604, and thus that the UE may obtain a preamble associated with that SSB for inclusion in message 1 but not message A. Thus, since two-step RACH may reduce latency compared to four-step RACH in low load scenarios while four-step RACH may result in better performance than two-step RACH in high load scenarios, this approach of enabling or disabling two-step RACH on a per beam basis allows the network to flexibly optimize load and latency across different SSB transmission beams.

Additionally, to further enhance load optimization, the network may indicate different PUSCH resources or occasions 808 in association with each transmission beam 408 of respective SSBs 402, allowing for more efficient resource allocation based on the specific characteristics of different beams. For example, rather than configuring a time and frequency offset for a PUSCH occasion based on an RO associated with an SSB which is beam-independent, such as previously described with respect to RO 608 and PUSCH occasion 610 of FIG. 6, here the base station may configure the time and frequency offset of the PUSCH occasion 808 to have a different value depending on the transmission beam 408 of the associated SSB 402. For instance, in the illustrated example, the PUSCH occasion 808 associated with the RO 806 corresponding to one SSB 402 (SSB1 in FIG. 8) may have a different frequency range than the PUSCH occasion 808 associated with the RO 806 corresponding to another SSB 402 (SSB4 in FIG. 8). Similarly in other examples, the PUSCH occasions 808 may have different time ranges, starting times, starting frequencies, number of RBs, or other parameters which may change depending on the SSB 402. Through this approach, wireless communication networks may better optimize resource allocation and enhance the efficiency of the 2-step RACH process, considering the varying load levels and latency requirements of different beam directions.

Still referring to FIG. 8, in a third aspect of a beam-specific configuration intended to enhance the efficiency of two-step RACH processes, the base station may configure one or more RSRP thresholds 810, 812 associated with two-step RACH processes to be beam-specific. In one example of this aspect, the base station may indicate a message A (msgA) SSB RSRP threshold 810 on a per-beam basis. More particularly, the base station may provide system information to the UE that indicates multiple msgA SSB RSRP thresholds 810, with each threshold 810 respectively being for selection of an SSB 402 associated with a different transmission beam 408. Each msgA SSB RSRP threshold 810 may be applied for the selection of an associated SSB 402 for two-step random access, in a similar manner to the SSB RSRP threshold 422 for four-step random access described with respect to FIG. 4B. For instance, the UE may determine whether the measured RSRP 406 of a particular SSB meets or exceeds the msgA SSB RSRP threshold 810 corresponding to that SSB 402 or transmission beam 408, and if the measured RSRP meets or exceeds the threshold, the UE may transmit message A including the preamble and PUSCH transmission associated with that SSB 402; otherwise, if the measured RSRP does not meet or exceed the threshold, the UE may not select that SSB for the preamble transmission of message A. Thus, this approach allows the network to consider the varying power requirements of different beams in two-step RACH processes, while similarly resulting in network energy savings over beam-independent broadcast configurations.

In another example of the third aspect, the base station may indicate a msgA RSRP threshold 812 on a per-beam basis. Generally, as illustrated in FIG. 6 and in cases where both two-step RACH and four-step RACH are available processes to a UE (such as when random access resources for both types of RACH processes are configured in an uplink bandwidth part), a msgA RSRP threshold such as RSRP threshold 602 is defined for selection between two-step random access 604 and four-step random access 606 regardless of, or independently of, the different transmission beams 408 of SSBs 402. However, this beam-independent approach of FIG. 6 may fail to consider the potentially different characteristics of these beams such as their differing power levels. Therefore, in this beam-specific configuration of FIG. 8, multiple msgA RSRP thresholds 812 may be configured, with each msgA RSRP threshold 812 being defined for selection between two-step random access 604 and four-step random access 606 in association with a particular SSB 402. For instance, the base station may provide system information indicating multiple msgA RSRP thresholds 812, with each threshold respectively being for selection between two-step RACH and four-step RACH in response to an SSB 402 associated with a different transmission beam 408. Thus, the network may optimize the efficiency of RACH processes while considering the potentially differing power requirements of respective transmission beams.

In a further example of the third aspect, the msgA RSRP threshold 812 may be applied in addition to, or alternatively in lieu of, the bitmap 802, set of SSB indexes 804, or other indication of whether two-step random access 604 is allowed for a particular beam 408 in accordance with the second aspect. In the former case where the msgA RSRP threshold 812 is applied in addition to the bitmap 802, set of SSB indexes 804, or similar indication, this combined approach may provide additional flexibility compared to applying the bitmap 802, set of SSB indexes 804, or other indication alone in configuring and determining the appropriate RACH type for a particular beam 408. For instance, in addition to providing the bitmap 802 indicating whether two-step random access 604 is allowed in association with a respective SSB 402, the base station may provide the msgA RSRP threshold 812 for that SSB 402 to configure or assist the UE in determining whether to apply two-step random access 604 or four-step random access 606 for that particular SSB 402. Thus, the base station may indicate not only whether two-step random access 604 is permitted via bitmap 802, but also whether two-step random access 604 or four-step random access 606 is to be applied via msg A RSRP threshold 812.

On the other hand, in the latter case where the msgA RSRP threshold 812 is applied in lieu of the bitmap 802, set of SSB indexes 804, or similar indication, this alternative approach may provide another mechanism for the base station to configure and the UE to determine which RACH type to use without relying on a bitmap or similar indication of whether or not two-step random access 604 is enabled. For instance, the base station may pre-configure two-step random access 604 and four-step random access 606 as possible random access types a UE may apply in association with an SSB 402 corresponding to a particular beam 408, and then configure the msgA RSRP threshold 812 for that associated SSB 402 to indicate which of these possible random access types is to be applied. Alternatively or additionally, the base station may configure the msgA RSRP threshold 812 for a certain beam 408 to be exceptionally low or exceptionally high, such that the configuration effectively forces the UE to select either two-step RACH or four-step RACH regardless of the measured RSRP 406 of the SSB associated with that certain beam. This approach allows the base station to effectively apply msgA RSRP thresholds 812 as enabling or disabling indicators of whether 2-step RACH is allowed or not in association with a particular beam 408 or SSB 402, without the additional overhead associated with transmission of bitmap 802 or similar indicator. For instance, in the illustrated example, instead of configuring bitmap 802 such that SSB2 is disabled from two-step random access (via setting a ‘0’ in bitmap 802 for that SSB or transmission beam 408), the base station may configure msgA RSRP threshold 812 for that beam 408 to be of such a high value that is impractical for the RSRP 406 of that SSB 402 to reach, effectively resulting in the same disablement of two-step random access for SSB2. Likewise, the base station may configure msgA RSRP threshold 812 for the beam 408 associated with SSB3 to be of such a low value that is impractical for the RSRP 406 of that SSB to fall below, effectively resulting in the same enablement of two-step random access for SSB3. Thus, similar to the second aspect, optimized resource allocation and enhanced efficiency of two-step RACH processes may be achieved while considering the specific needs and requirements of different beams, while also saving system information resources or overhead compared to the second aspect.

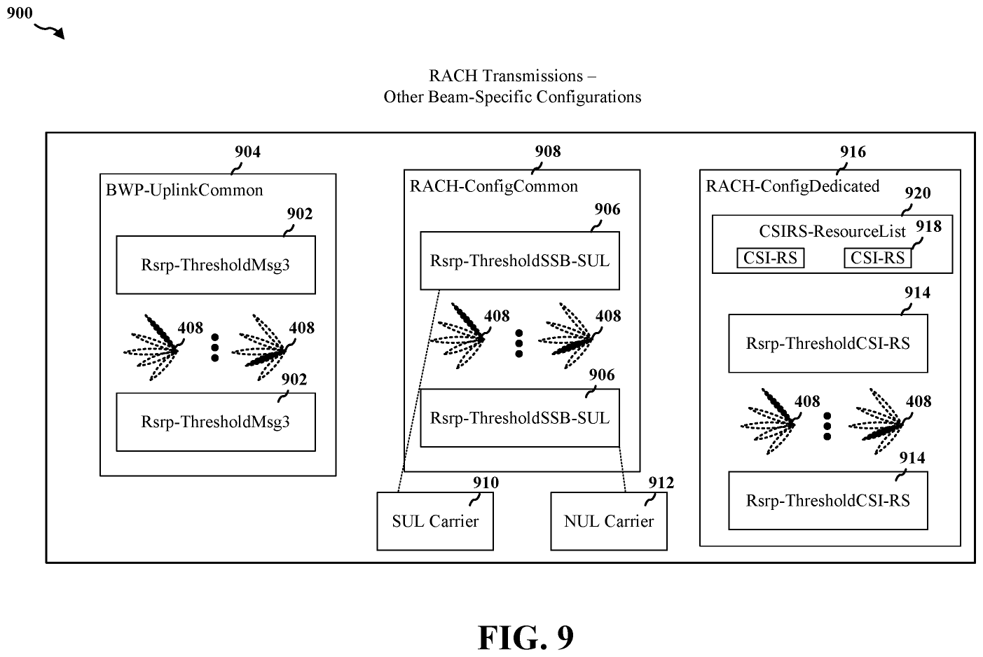

FIG. 9 illustrate examples 900 of further aspects of beam-specific configurations to enhance the efficiency of RACH processes. In one example of a fourth aspect of a beam-specific configuration, the base station may configure a message 3 RSRP threshold 902 to be beam-specific. For instance, the base station may provide a BWP uplink common configuration 904 (such as the configuration BWP-UplinkCommon) indicating multiple message 3 RSRP thresholds 902 respectively associated with different SSB transmission beams 408 for determining whether to send message 3 PUSCH repetitions in a 4-step RACH process. Each message 3 RSRP threshold 902 may be applied by the UE to determine whether to select resources indicating msg3 repetition in a specific BWP, or to transmit a number of repetitions of message 3 in a 4-step RACH process, based on a measured RSRP 406 of the SSB 402 with the associated transmission beam 408. For instance, the UE may determine whether the measured RSRP 406 of a particular SSB falls below the message 3 RSRP threshold 902 corresponding to that SSB 402 or transmission beam 408, and if the measured RSRP being below the threshold, the UE may transmit message 3 including the PUSCH transmission associated with that SSB 402 with repetitions; otherwise, if the measured RSRP does not exist below the threshold, the UE may not repeat its message 3 or PUSCH transmission in association with that SSB 402. Thus, this approach may provide flexibility in determining whether message 3 repetition is appropriate for each beam based on the unique characteristics and conditions of each beam direction.

Referring again to FIG. 9, in one example of a fifth aspect of a beam-specific configuration, the base station may configure a supplemental uplink carrier (SUL) SSB RSRP threshold 906 to be beam-specific. For instance, the base station may provide a common RACH configuration 908 (such as the configuration RACH-ConfigCommon) indicating multiple SUL SSB RSRP thresholds 906 respectively associated with different transmission beams 408 of SSBs 402 for selecting between normal uplink carriers (NULs) and SULs. Each SUL SSB RSRP threshold 906 may be applied by the UE to determine whether to select an SUL carrier 910 or an NUL carrier 912 for performing random access in response to an associated SSB 402 in a respective transmission beam 408. For example, the UE may select SUL carrier 910 for performing RACH, using a preamble associated with an SSB 402 received in one transmission beam 408, in response to the measured RSRP 406 of that SSB 402 being below one associated SUL SSB RSRP threshold 906, while the UE may select NUL carrier 912 for performing RACH, using a preamble associated with another SSB 402 received in a different transmission beam 408, in response to the measured RSRP 406 of that SSB 402 being at or above another associated SUL SSB RSRP threshold 906. Each SUL SSB RSRP threshold 906 per beam 408 may also be applied to all BWPs and all RACH configurations. Thus, this approach may provide flexibility in determining an appropriate carrier selection for random access associated with each beam based on the unique characteristics and conditions of each beam direction, while efficiently managing the allocation of resources between NUL and SUL carriers.

Still referring to FIG. 9, in one example of a sixth aspect of a beam-specific configuration, the base station may configure a CSI-RS RSRP threshold 914 for CSI-RS-based contention-free random access (CFRA) to be beam-specific. For instance, the base station may provide a dedicated RACH configuration 916 (such as the configuration RACH-ConfigDedicated), an RRC reconfiguration, or other configuration indicating multiple CSI-RS RSRP thresholds 914 respectively associated with different transmission beams 408 of CSI-RSs 918 to be selected for CFRA. The CSI-RSs 918 may be configured in a CSI-RS resource list of multiple CFRA-CSI-RS resources 920, and each CSI-RS RSRP threshold 914 may be applied by the UE to determine whether to perform CFRA using a preamble associated with the corresponding CSI-RS 918 in a respective transmission beam 408. For example, the UE may perform CFRA using a preamble associated with one CSI-RS 918 received in one transmission beam 408 in response to the RSRP 406 of that CSI-RS 918 exceeding its associated CSI-RSRP threshold 914, while the UE may perform CFRA using another preamble associated with another CSI-RS 918 received in a different transmission beam 408 in response to the RSRP 406 of that other CSI-RS 918 exceeding its associated CSI-RSRP threshold 914. Since the CSI-RSs 918 may be transmitted with different power levels based on beam direction and thus have different RSRPs 406, similar to SSBs 402, this approach may provide flexibility to the UE in determining the appropriate CFRA for each beam based on the distinct characteristics and conditions of each beam direction.

Lastly, in an example of a seventh aspect to enhance the efficiency of RACH processes, and referring back this time to FIG. 8, the base station may map SSBs 402 to ROs 806 based on one or more of the beam-specific configurations referenced in any of the previously described aspects. Currently, SS/PBCH block indexes 804 that are provided in an SIB1 or a common serving cell configuration, such as via the parameter ssb-PositionsinBurst, are mapped to valid PRACH occasions or ROs 806 in the following order: first, in increasing order of preamble indexes within a single PRACH occasion, second, in increasing order of frequency resource indexes for frequency multiplexed PRACH occasions, third, in increasing order of time resource indexes for time multiplexed PRACH occasions within a PRACH slot, and fourth, in increasing order of indexes for PRACH slots. However, this mapping fails to consider beam-specific characteristics of the SSBs 402 corresponding to these SS/PBCH block indexes 804. For example, SSBs 402 may be mapped to ROs 806 regardless or independently of whether these SSBs are enabled in use for two-step random access 604 and four-step random access 606, whether these SSBs are restricted in use to four-step random access 606, or whether these SSBs 402 more generally meet or exceed their beam-specific thresholds, such as one or more of thresholds 702, 704, 722, 724, 810, 812, 902, 906, 914. Since such beam-independent mapping may result in inefficiencies in the RACH process, the base station in this example may configure, and the UE may determine, a mapping of SSBs 402 to ROs 806 based on beam-specific configurations for those SSBs 402. More particularly, the base station may map SSBs 402 associated with different transmission beams 408 to ROs 806 in the aforementioned order not only in response to their corresponding SS/PBCH block indexes 804 being provided in the SIB1 or common serving cell configuration, but also in response to their SS/PBCH block indexes 804 or other identifiers being selected for random access based on beam-specific parameters. For instance, the base station may map SSBs 402 to ROs 806 in the aforementioned order in response to the RSRPs 406 of these SSBs 402 meeting or exceeding their beam-specific thresholds, such as one or more of thresholds 702, 704, 722, 724, 810, 812, 902, 906, 914. As an example, SSBs 402 may be mapped to ROs 806 if their SS/PBCH block indexes 804 are indicated in the set of SSB indexes 804 (via a parameter msgA-SSBset) in response to the SS/PBCH block index 804 of a particular SSB 402 associated with a respective transmission beam 408 including an RSRP 406 that meets or exceeds an associated msgA RSRP threshold 812. Thus, by mapping SSBs 402 to ROs 806 based on beam-specific configurations of these SSBs 402, the network may effectively manage resource allocation of ROs 806 for SSBs 402 based on the unique characteristics and conditions of each beam direction.

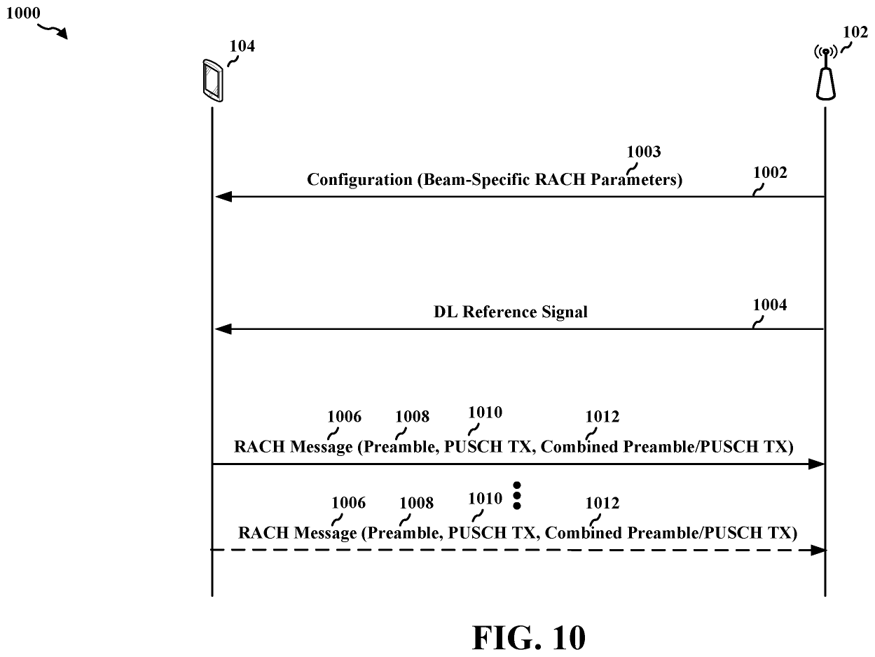

FIG. 10 illustrates an example 1000 of a call flow between UE 104 and base station 102. Initially, the base station 102 transmits, and the UE 104 receives, a configuration 1002 including one or more beam-specific RACH parameters 1003. For example, the configuration 1002 may be a system information block, a common serving cell configuration, a common RACH configuration, a dedicated RACH configuration, a RRC reconfiguration, or other configuration including beam-specific RACH parameters 1003. In some examples, the configuration 1002 may also indicate a plurality of reference signal resources respectively associated with the beam-specific RACH parameters 1003, such as CSI-RS resources 920 for CFRA. In various examples, the beam-specific RACH parameters 1003 may include: a plurality of SSB RSRP thresholds such as SSB RSRP thresholds 702, 704, 722, 724, a two-step RACH parameter such as bitmap 802, a two-step RACH threshold such as msgA SSB RSRP threshold 810 or msgA RSRP threshold 812, a PUSCH RSRP threshold such as msg3 RSRP threshold 902, a SUL RSRP threshold such as SUL SSB RSRP threshold 906, or a CSI-RS RSRP threshold such as CSI-RS RSRP threshold 914. In some examples, the beam-specific RACH parameters 1003 may also include PUSCH resource 808 for two-step random access 604. After receiving the configuration 1002 including the beam-specific RACH parameters 1003, the base station 102 transmits, and the UE 104 receives, a downlink reference signal 1004. The downlink reference signal 1004 may be, for example, SSB 402 or CSI-RS 918, either of which may be received in respective transmission beam 408.

The downlink reference signal 1004 or its transmission beam 408 may be associated with the beam-specific RACH parameters 1003. In one example where the beam-specific RACH parameters 1003 include SSB RSRP thresholds 702, 704, 722, 724, the SSB RSRP thresholds may be configured for selection of a single SSB for four-step random access 606, such as described with respect to FIGS. 7A-7B in the first aspect. Thus, the downlink reference signal 1004 associated with SSB RSRP thresholds may be the single SSB 402 in this example. In one example where the beam-specific RACH parameters 1003 include a two-step RACH parameter, the two-step RACH parameter may be the bitmap 802, a set of identifiers or indexes 804, or other parameter indicating whether two-step random access 604 is enabled in association with a specific SSB 402, such as described with respect to FIG. 8 in the second aspect. Thus, the downlink reference signal 1004 associated with the two-step RACH parameter may be the specific SSB 402 in this example. In one example where the beam-specific RACH parameters 1003 include the two-step RACH threshold, the two-step RACH threshold may be a two-step SSB RSRP threshold for selection of an SSB for two-step random access, such as msgA SSB RSRP threshold 810 in one example of the third aspect. Thus, the downlink reference signal 1004 associated with the two-step SSB RSRP threshold may be the SSB 402 in this example. In another example, the two-step RACH threshold may be an RSRP threshold of an SSB and may be configured for selection between two-step random access 604 and four-step random access 606, such as msgA RSRP threshold 812 in another example of the third aspect. Thus, the downlink reference signal 1004 associated with the RSRP threshold may be the SSB 402 in this example. In some cases, the RSRP threshold may be configured such that two-step random access 604 is only enabled or only disabled in association with the downlink reference signal 1004. In one example where the beam-specific RACH parameters 1003 include the PUSCH RSRP threshold such as msg3 PUSCH RSRP threshold 902, the PUSCH RSRP threshold may be configured for repetitions of a PUSCH transmission in four-step random access 606, such as described with respect to the fourth aspect, where the repeated PUSCH transmission is responsive to a RAR following UE transmission of a preamble associated with an SSB 402. Thus, the downlink reference signal 1004 associated with the PUSCH RSRP threshold may be the SSB 402 in this example. In one example where the beam-specific RACH parameters 1003 include the SUL RSRP threshold such as SUL SSB RSRP threshold 906, the SUL RSRP threshold may be configured for selection between NUL carrier 912 and SUL carrier 910 for four-step random access 606 or two-step random access 604, such as described with respect to the fifth aspect, where the random access includes UE transmission of a preamble associated with an SSB 402. Thus, the downlink reference signal 1004 associated with the SUL RSRP threshold may be the SSB 402 in this example. In one example where the beam-specific RACH parameters 1003 include the CSI-RS RSRP threshold 914, the CSI-RS RSRP threshold may be for selection of a CSI-RS 918 for four-step random access, such as described with respect to the sixth aspect, where the four-step random access 606 includes UE transmission of a preamble associated with the CSI-RS 918. Thus, the downlink reference signal 1004 associated with the CSI-RS RSRP threshold may be the CSI-RS 918 in this example.

Following reception of the downlink reference signal 1004, the UE 104 may transmit, and the base station 102 may receive, a RACH message 1006 associated with the downlink reference signal 1004 based on the beam-specific RACH parameters 1003. In various examples, the RACH message 1006 may include, for example, a preamble 1008 or PRACH transmission or message 1 in four-step random access 606, a PUSCH transmission 1010 or message 3 in four-step random access 606, or a combined PRACH and PUSCH transmission 1012 or message A in two-step random access 604. The preamble 1008 may be associated with the downlink reference signal 1004 such as SSB 402, the RO 806 for preamble 1008 may be mapped to the downlink reference signal 1004 such as SSB 402 in accordance with the seventh aspect described above, and the PUSCH resource 808 for PUSCH transmission 1010 may be derived based on the RO 806. Thus, the RACH message 1006 may be associated with the downlink reference signal 1004 in that it may include the preamble 1008, PUSCH transmission 1010, or combined PRACH/PUSCH transmission 1012.

In one example where the beam-specific RACH parameters 1003 include the SSB RSRP thresholds 702, 704, 722, 724, the UE 104 may transmit the RACH message 1006 based on the plurality of SSB RSRP thresholds, such as described with respect to FIGS. 7A-7B in the first aspect. For example, the UE 104 may transmit the RACH message 1006 according to a number of preamble transmissions 501 or repetitions based on a measured RSRP 406 of the downlink reference signal 1004 compared to the SSB RSRP thresholds 702, 704, 722, 724. For instance, as described with respect to FIGS. 7A-7B in the first aspect, the UE may compare the measured RSRP 406 of an SSB 402 to the SSB RSRP thresholds 702, 704, 722, 724 and include the preamble 1008 associated with that SSB 402 in one, two, or four preamble transmissions 501 depending on which threshold(s) the measured RSRP 406 meets or does not exceed. In one example where the beam-specific RACH parameters 1003 include the two-step RACH parameter, the UE may include the RACH preamble 1008 and the PUSCH transmission 1010 in the RACH message 1006 to form combined PRACH/PUSCH transmission 1012 or message A based on the two-step RACH parameter. For instance, as described with respect to FIG. 8 in the second aspect, the UE 104 may determine from bitmap 802 whether the SSB 402 associated with combined PRACH/PUSCH transmission 1012 or RACH preamble 1008 is enabled for two-step random access 604, in response to which determination the UE 104 may transmit message A. In one example where the beam-specific RACH parameters 1003 include the two-step RACH parameter and further include the PUSCH resource 808 for two-step random access, the UE may transmit the PUSCH transmission 1010 in the PUSCH resource 808. In one example where the beam-specific RACH parameters 1003 include the two-step RACH threshold, the UE may include the RACH preamble 1008 associated with the SSB 402 in the RACH message 1006 based on the two-step RACH threshold. For instance, as previously described with respect to the third aspect in FIG. 8, the UE 104 may compare the measured RSRP 406 of an SSB 402 to the msgA SSB RSRP threshold 810 and include the preamble 1008 associated with that SSB 402 in the RACH message 1006 in response to the measured RSRP meeting or exceeding the threshold. In another example, the UE may include either a RACH preamble or a combined RACH preamble and PUSCH transmission in the RACH message based on the RSRP threshold. For instance, as also previously described with respect to the third aspect in FIG. 8, the UE 104 may compare the measured RSRP 406 of an SSB 402 to the msgA RSRP threshold 812 and include combined PRACH/PUSCH transmission 1012 in RACH message 1006 in response to the measured RSRP meeting or exceeding the threshold.

In one example where the beam-specific RACH parameters 1003 include the PUSCH RSRP threshold, the UE 104 may include a repetition of PUSCH transmission 1010 in the RACH message 1006 based on the PUSCH RSRP threshold. For instance, as described with respect to the fourth aspect in FIG. 9, the UE may compare the measured RSRP 406 of an SSB 402 to the msg3 PUSCH RSRP threshold 902, and in response to the RSRP being below the threshold, the UE may transmit multiple RACH messages 1006 including repetitions of PUSCH transmission 1010. In one example where the beam-specific RACH parameters 1003 include the SUL RSRP threshold, the UE may transmit the RACH message in either the SUL carrier 910 or the NUL carrier 912 based on the SUL RSRP threshold. For instance, as described with respect to the fifth aspect in FIG. 9, the UE may compare the measured RSRP 406 of an SSB 402 to the SUL SSB RSRP threshold 906, and in response to the RSRP being below the threshold, the UE may transmit the RACH message 1006 in the SUL carrier 910. Alternatively, if the RSRP is above the threshold, the UE may transmit the RACH message 1006 in the NUL carrier 912. In one example where the beam-specific RACH parameters 1003 include the CSI-RS RSRP threshold 914, the UE may include a RACH preamble associated with the CSI-RS in the RACH message based on the CSI-RS RSRP threshold. For instance, as described with respect to the sixth aspect, the UE 104 may compare the measured RSRP 406 of a CSI-RS 918 to the CSI-RS RSRP threshold 914 and include the preamble 1008 associated with that CSI-RS 918 in the RACH message 1006 in response to the measured RSRP meeting or exceeding the threshold.

Finally, in one example where the downlink reference signal 1004 is an SSB 402, an SSB index 804 associated with the SSB 402 may be mapped to an RO 806 based on the beam-specific RACH parameters 1003, and the UE 104 may transmit and the base station 102 may receive the RACH message 1006 in this RO 806. For instance, as described with respect to the seventh aspect, in response to determining that the measured RSRP 406 of an SSB 402 meets or exceeds (or exists below) one or more beam-specific thresholds associated with that SSB 402, such as thresholds 702, 704, 722, 724, 810, 812, 902, 906, 914, or that the SS/PBCH block index 804 of the SSB 402 is indicated in the set of SSB indexes 804 enabled for two-step random access 604, the UE 104 may determine that the RO 806 associated with this SSB 402 may be among the plurality of ROs mapped to SSBs according to the following order: first, in increasing order of preamble indexes within a single PRACH occasion, second, in increasing order of frequency resource indexes for frequency multiplexed PRACH occasions, third, in increasing order of time resource indexes for time multiplexed PRACH occasions within a PRACH slot, and fourth, in increasing order of indexes for PRACH slots. As a result, the UE 104 may transmit the RACH preamble 1008 associated with that SSB 402 in the RO 806 mapped to this SSB 402.

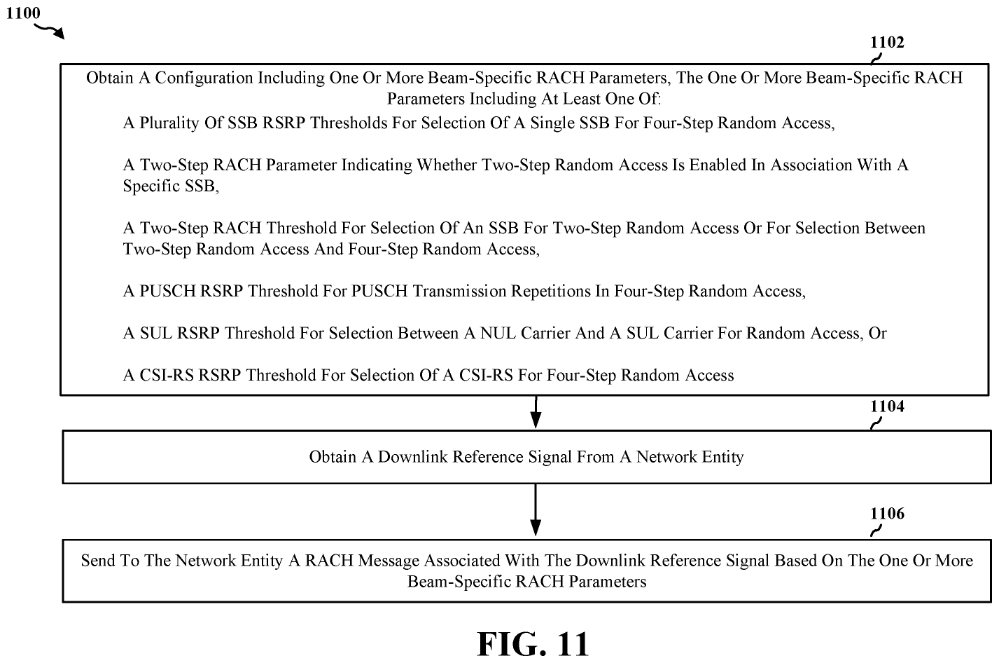

FIG. 11 is a flowchart 1100 of a method of wireless communication. The method may be performed by a UE or one or more of its components, for example, the UE 104, 350; one or more of RX processor(s) 356, TX processor(s) 368, or controller(s)/processor(s) 359; the apparatus 1302; or cellular baseband processor(s) 1304 or its components. The method allows a UE to optimize RACH processes by utilizing beam-specific RACH parameters for RACH messaging.

At block 1102, the UE obtains a configuration including one or more beam-specific RACH parameters. For example, 1102 may be performed by configuration component 1340. The one or more beam-specific RACH parameters include at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. Obtaining the configuration may include, for example, receiving, demodulating, and decoding an encoded and modulated signal including the configuration using one or more of RX processor(s) 356 or controller(s)/processor(s) 359 such as described with respect to UE 350 in FIG. 3. For instance, referring to FIG. 10, the UE 104, 350 may receive configuration 1002 including one or more beam-specific RACH parameters 1003. In various examples, the beam-specific RACH parameters 1003 may include: a plurality of SSB RSRP thresholds such as SSB RSRP thresholds 702, 704, 722, 724, a two-step RACH parameter such as bitmap 802, a two-step RACH threshold such as msgA SSB RSRP threshold 810 or msgA RSRP threshold 812, a PUSCH RSRP threshold such as msg3 RSRP threshold 902, a SUL RSRP threshold such as SUL SSB RSRP threshold 906, or a CSI-RS RSRP threshold such as CSI-RS RSRP threshold 914.

At block 1104, the UE obtains a downlink reference signal from a network entity. For example, 1104 may be performed by reference signal component 1342. Obtaining the downlink reference signal may include, for example, receiving, demodulating, and decoding an encoded and modulated signal including the downlink reference signal using one or more of RX processor(s) 356 or controller(s)/processor(s) 359 such as described with respect to UE 350 in FIG. 3. For instance, referring to FIG. 10, after receiving the configuration 1002 including the beam-specific RACH parameters 1003, the base station 102 transmits, and the UE 104, 350 receives, downlink reference signal 1004. The downlink reference signal 1004 may be, for example, SSB 402 or CSI-RS 918, either of which may be received in respective transmission beam 408.

At block 1106, the UE sends to the network entity a RACH message associated with the downlink reference signal based on the one or more beam-specific RACH parameters. For example, 1106 may be performed by RACH message component 1344. Sending the RACH message may include, for example, transmitting, modulating, and encoding the RACH message using one or more of the TX processor(s) 368 or controller(s)/processor(s) 359, such as described with respect to UE 350 in FIG. 3. For instance, as described with respect to FIG. 10, following reception of the downlink reference signal 1004, the UE 104 may transmit, and the base station 102 may receive, RACH message 1006 associated with the downlink reference signal 1004, where the RACH message 1006 or its transmission is further based on the beam-specific RACH parameters 1003 such as described with respect to FIG. 10.

In one example, the one or more beam-specific RACH parameters include the plurality of SSB RSRP thresholds, the downlink reference signal is the single SSB, and the RACH message is sent based on the plurality of SSB RSRP thresholds, such as described with respect to FIGS. 7A-7B and the first aspect referenced in FIG. 10. In one example, the configuration obtained at block 1102 is a SIB including the plurality of SSB RSRP thresholds. In one example, the RACH message is sent according to a number of repetitions based on a measured RSRP of the single SSB compared to the plurality of SSB RSRP thresholds, such as described and illustrated with respect to FIGS. 7A-7B and FIG. 10 in connection with different numbers of preamble transmissions 501. In one example, SSBs including the single SSB that are respectively associated with different transmission beams are associated with a same number of SSB RSRP thresholds or of RACH preamble repetitions, such as described and illustrated with respect to FIG. 7A. In one example, the configuration obtained at block 1102 indicates different numbers of SSB RSRP thresholds or of RACH preamble repetitions for SSBs including the single SSB that are respectively associated with different transmission beams, such as described and illustrated with respect to FIG. 7B.

In one example, the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter, such as described with respect to the second aspect in FIG. 8 and FIG. 10. In one example, the two-step RACH parameter is a bitmap associated with a plurality of SSBs including the specific SSB, or a set of identifiers respectively associated with the SSBs, indicating whether two-step random access is enabled in association with respective ones of the SSBs, such as described and illustrated with respect to FIG. 8 in connection with bitmap 802 or set of SSB identifiers or indexes 804. In one example, the one or more beam-specific RACH parameters further include a PUSCH resource for two-step random access, and the PUSCH transmission is sent in the PUSCH resource, such as described and illustrated with respect to FIG. 8.

In one example, the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold, such as described with respect to the third aspect in FIG. 8 and FIG. 10 with reference to msgA SSB RSRP threshold 810. In one example, the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold, such as described with respect to the third aspect in FIG. 8 and FIG. 10 with reference to msgA RSRP threshold 812. In one example, the RSRP threshold is configured such that two-step random access is only enabled or only disabled in association with the downlink reference signal, such as described and illustrated in FIG. 8 in connection with msgA RSRP threshold 812 being configured to be an enabling or disabling indicator of whether 2-step RACH is allowed or not.

In one example, the one or more beam-specific RACH parameters include the PUSCH RSRP threshold, and the RACH message includes a repetition of a PUSCH transmission based on the PUSCH RSRP threshold, such as described with respect to the fourth aspect in FIG. 9 and FIG. 10. In one example, the one or more beam-specific RACH parameters include the SUL RSRP threshold, and the RACH message is sent in the SUL carrier or the NUL carrier based on the SUL RSRP threshold, such as described with respect to the fifth aspect in FIG. 9 and FIG. 10. In one example, the one or more beam-specific RACH parameters include the CSI-RS RSRP threshold, the downlink reference signal is the CSI-RS, and the RACH message includes a RACH preamble associated with the CSI-RS based on the CSI-RS RSRP threshold, such as described with respect to the sixth aspect in FIG. 9 and FIG. 10. In one example, the configuration indicates a plurality of CSI-RS resources including a CSI-RS resource associated with the CSI-RS, and the configuration further indicates a plurality of CSI-RS RSRP thresholds including the CSI-RS RSRP threshold which are respectively associated with the plurality of CSI-RS resources, such as described with respect to FIG. 9 in connection with CFRA-CSI-RS resources 920. In one example, the RACH message is sent in an RO mapped to an SSB index associated with the downlink reference signal based on the one or more beam-specific RACH parameters, such as described with respect to the seventh aspect referenced in FIG. 8 and FIG. 10.

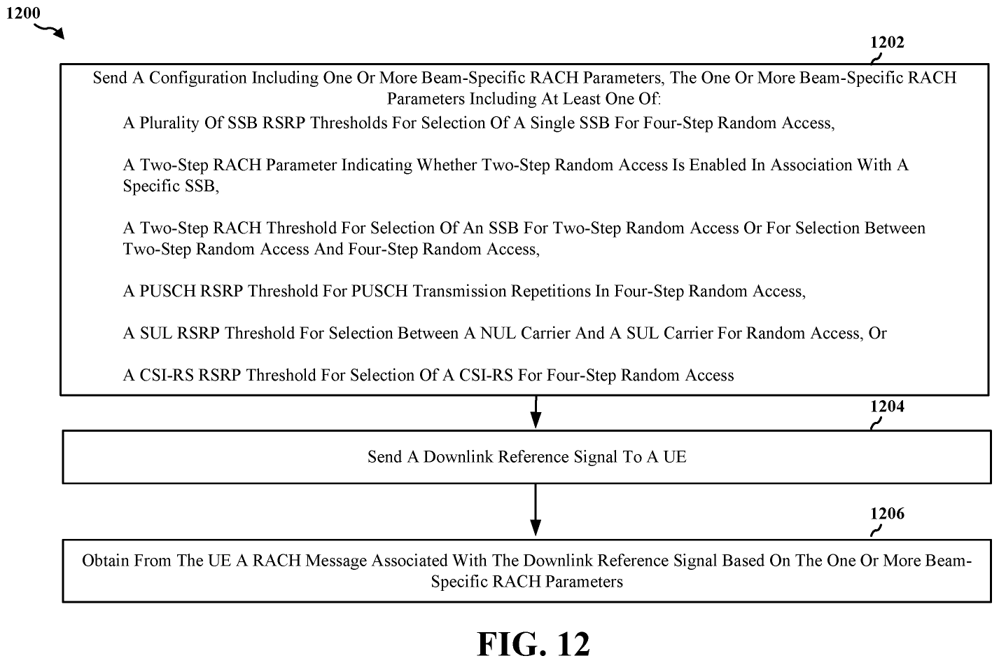

FIG. 12 is a flowchart 1200 of a method of wireless communication. The method may be performed by a network entity such as a base station or one or more of its components, for example, the base station 102/180, 310; disaggregated base station 181 or one or more of its components; one or more of RX processor(s) 370, TX processor(s) 316, or controller(s)/processor(s) 375; the apparatus 1402; or baseband unit(s) 1404 or its components. The method allows a network entity to optimize RACH processes by configuring beam-specific RACH parameters for RACH messaging.

At block 1202, the network entity sends a configuration including one or more beam-specific RACH parameters. For example, 1202 may be performed by configuration component 1440. The one or more beam-specific RACH parameters include at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. Sending the configuration may include, for example, transmitting, modulating, and encoding the configuration using one or more of the TX processor(s) 316 or controller(s)/processor(s) 375, such as described with respect to BS 310 in FIG. 3. For instance, referring to FIG. 10, the base station 102, 310 may transmit configuration 1002 including one or more beam-specific RACH parameters 1003. In various examples, the beam-specific RACH parameters 1003 may include: a plurality of SSB RSRP thresholds such as SSB RSRP thresholds 702, 704, 722, 724, a two-step RACH parameter such as bitmap 802, a two-step RACH threshold such as msgA SSB RSRP threshold 810 or msgA RSRP threshold 812, a PUSCH RSRP threshold such as msg3 RSRP threshold 902, a SUL RSRP threshold such as SUL SSB RSRP threshold 906, or a CSI-RS RSRP threshold such as CSI-RS RSRP threshold 914.

At block 1204, the network entity sends a downlink reference signal to a UE. For example, 1204 may be performed by reference signal component 1442. Sending the downlink reference signal may include, for example, transmitting, modulating, and encoding the signal using one or more of the TX processor(s) 316 or controller(s)/processor(s) 375, such as described with respect to BS 310 in FIG. 3. For instance, referring to FIG. 10, after transmitting the configuration 1002 including the beam-specific RACH parameters 1003, the base station 102 transmits, and the UE 104, 350 receives, downlink reference signal 1004. The downlink reference signal 1004 may be, for example, SSB 402 or CSI-RS 918, either of which may be transmitted in respective transmission beam 408.

At block 1206, the network entity obtains from the UE a RACH message associated with the downlink reference signal based on the one or more beam-specific RACH parameters. For example, 1206 may be performed by RACH message component 1444. Obtaining the RACH message may include, for example, receiving, demodulating, and decoding an encoded and modulated signal including the RACH message using one or more of RX processor(s) 370 or controller(s)/processor(s) 375 such as described with respect to BS 310 in FIG. 3. For instance, as described with respect to FIG. 10, following reception of the downlink reference signal 1004, the UE 104 may transmit, and the base station 102 may receive, RACH message 1006 associated with the downlink reference signal 1004, where the RACH message 1006 or its reception is further based on the beam-specific RACH parameters 1003 such as described with respect to FIG. 10.

In one example, the one or more beam-specific RACH parameters include the plurality of SSB RSRP thresholds, the downlink reference signal is the single SSB, and the RACH message is obtained based on the plurality of SSB RSRP thresholds, such as described with respect to FIGS. 7A-7B and the first aspect referenced in FIG. 10. In one example, the configuration sent at block 1202 is a SIB including the plurality of SSB RSRP thresholds. In one example, the RACH message is obtained according to a number of repetitions based on a measured RSRP of the single SSB compared to the plurality of SSB RSRP thresholds, such as described and illustrated with respect to FIGS. 7A-7B and FIG. 10 in connection with different numbers of preamble transmissions 501. In one example, SSBs including the single SSB that are respectively associated with different transmission beams are associated with a same number of SSB RSRP thresholds or of RACH preamble repetitions, such as described and illustrated with respect to FIG. 7A. In one example, the configuration sent at block 1202 indicates different numbers of SSB RSRP thresholds or of RACH preamble repetitions for SSBs including the single SSB that are respectively associated with different transmission beams, such as described and illustrated with respect to FIG. 7B.

In one example, the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter, such as described with respect to the second aspect in FIG. 8 and FIG. 10. In one example, the two-step RACH parameter is a bitmap associated with a plurality of SSBs including the specific SSB, or a set of identifiers respectively associated with the SSBs, indicating whether two-step random access is enabled in association with respective ones of the SSBs, such as described and illustrated with respect to FIG. 8 in connection with bitmap 802 or set of SSB identifiers or indexes 804. In one example, the one or more beam-specific RACH parameters further include a PUSCH resource for two-step random access, and the PUSCH transmission is obtained in the PUSCH resource, such as described and illustrated with respect to FIG. 8.

In one example, the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold, such as described with respect to the third aspect in FIG. 8 and FIG. 10 with reference to msgA SSB RSRP threshold 810. In one example, the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold, such as described with respect to the third aspect in FIG. 8 and FIG. 10 with reference to msgA RSRP threshold 812. In one example, the RSRP threshold is configured such that two-step random access is only enabled or only disabled in association with the downlink reference signal, such as described and illustrated in FIG. 8 in connection with msgA RSRP threshold 812 being configured to be an enabling or disabling indicator of whether 2-step RACH is allowed or not.

In one example, the one or more beam-specific RACH parameters include the PUSCH RSRP threshold, and the RACH message includes a repetition of a PUSCH transmission based on the PUSCH RSRP threshold, such as described with respect to the fourth aspect in FIG. 9 and FIG. 10. In one example, the one or more beam-specific RACH parameters include the SUL RSRP threshold, and the RACH message is obtained in the SUL carrier or the NUL carrier based on the SUL RSRP threshold, such as described with respect to the fifth aspect in FIG. 9 and FIG. 10. In one example, the one or more beam-specific RACH parameters include the CSI-RS RSRP threshold, the downlink reference signal is the CSI-RS, and the RACH message includes a RACH preamble associated with the CSI-RS based on the CSI-RS RSRP threshold, such as described with respect to the sixth aspect in FIG. 9 and FIG. 10. In one example, the configuration indicates a plurality of CSI-RS resources including a CSI-RS resource associated with the CSI-RS, and the configuration further indicates a plurality of CSI-RS RSRP thresholds including the CSI-RS RSRP threshold which are respectively associated with the plurality of CSI-RS resources, such as described with respect to FIG. 9 in connection with CFRA-CSI-RS resources 920. In one example, the RACH message is obtained in an RO mapped to an SSB index associated with the downlink reference signal based on the one or more beam-specific RACH parameters, such as described with respect to the seventh aspect referenced in FIG. 8 and FIG. 10.

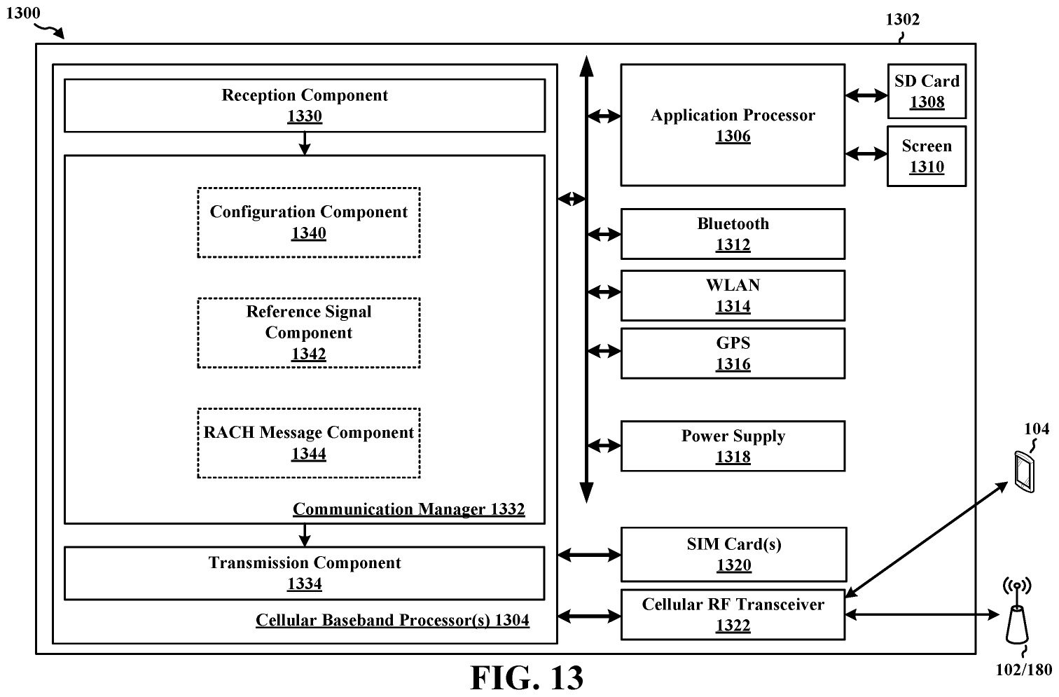

FIG. 13 is a diagram 1300 illustrating an example of a hardware implementation for an apparatus 1302. The apparatus 1302 is a UE and includes one or more cellular baseband processors 1304 (also referred to as a modem) coupled to a cellular RF transceiver 1322 and one or more subscriber identity modules (SIM) cards 1320, an application processor 1306 coupled to a secure digital (SD) card 1308 and a screen 1310, a Bluetooth module 1312, a wireless local area network (WLAN) module 1314, a Global Positioning System (GPS) module 1316, and a power supply 1318. The one or more cellular baseband processors 1304 communicate through the cellular RF transceiver 1322 with the UE 104 and/or BS 102/180/disaggregated base station 181. The one or more cellular baseband processors 1304 may each include a computer-readable medium/one or more memories. The computer-readable medium/one or more memories may be non-transitory. The one or more cellular baseband processors 1304 are responsible for general processing, including the execution of software stored on the computer-readable medium/one or more memories individually or in combination. The software, when executed by the one or more cellular baseband processors 1304, causes the one or more cellular baseband processors 1304 to, individually or in combination, perform the various functions described supra. The computer-readable medium/one or more memories may also be used individually or in combination for storing data that is manipulated by the one or more cellular baseband processors 1304 when executing software. The one or more cellular baseband processors 1304 individually or in combination further include a reception component 1330, a communication manager 1332, and a transmission component 1334. The communication manager 1332 includes the one or more illustrated components. The components within the communication manager 1332 may be stored in the computer-readable medium/one or more memories and/or configured as hardware within the one or more cellular baseband processors 1304. The one or more cellular baseband processors 1304 may be components of the UE 350 and may individually or in combination include the one or more memories 360 and/or at least one of the one or more TX processors 368, at least one of the one or more RX processors 356, and at least one of the one or more controllers/processors 359. For example, the reception component 1330 may include at least the one or more RX processors 356, the transmission component 1334 may include at least the one or more TX processors 368, and the communication manager 1332 may include at least the one or more controllers/processors 359. In one configuration, the apparatus 1302 may be a modem chip and include just the one or more baseband processors 1304, and in another configuration, the apparatus 1302 may be the entire UE (e.g., see 350 of FIG. 3) and include the aforediscussed additional modules of the apparatus 1302.

The communication manager 1332 includes a configuration component 1340 that is configured to obtain, for example via reception component 1330, a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access, such as described in connection with block 1102. The communication manager 1332 may further include a reference signal component 1342 that is configured to obtain, for example via reception component 1330, a downlink reference signal from a network entity, such as described in connection with block 1104. The communication manager 1332 may further include a RACH message component 1344 that is configured to send to the network entity, for example via transmission component 1334, a RACH message associated with the downlink reference signal based on the one or more beam-specific RACH parameters, such as described in connection with block 1106.

The apparatus may include additional components that perform each of the blocks of the algorithm in the aforementioned flowchart of FIG. 11. As such, each block in the aforementioned flowchart of FIG. 11 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1302, and in particular one or more cellular baseband processors 1304, includes means for obtaining a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The means for obtaining may be further configured to obtain a downlink reference signal from a network entity. Moreover, the apparatus 1302, and in particular one or more cellular baseband processors 1304, includes means for sending to the network entity a RACH message associated with the downlink reference signal based on the one or more beam-specific RACH parameters.

The aforementioned means may be one or more of the aforementioned components of the apparatus 1302 configured to perform the functions recited by the aforementioned means. As described supra, the apparatus 1302 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

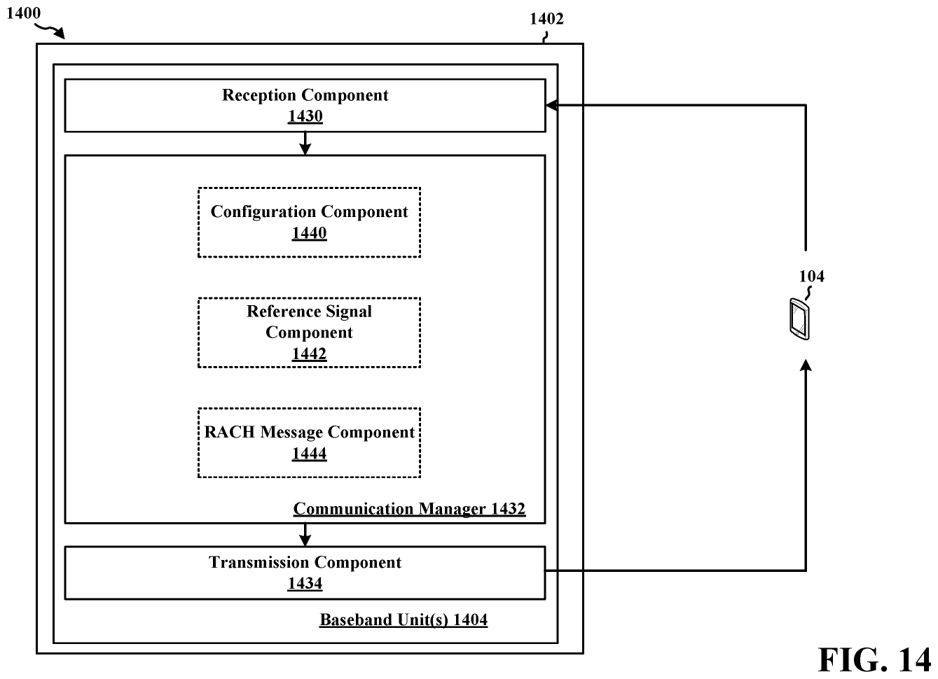

FIG. 14 is a diagram 1400 illustrating an example of a hardware implementation for an apparatus 1402. The apparatus 1402 is a network entity such as a base station and includes one or more baseband units 1404. The one or more baseband units 1404 communicate through a cellular RF transceiver with the UE 104. The one or more baseband units 1404 may each include a computer-readable medium/one or more memories. The computer-readable medium/one or more memories may be non-transitory. The one or more baseband units 1404 are responsible for general processing, including the execution of software stored on the computer-readable medium/one or more memories individually or in combination. The software, when executed by the one or more baseband units 1404, causes the one or more baseband units 1404 to, individually or in combination, perform the various functions described supra. The computer-readable medium/one or more memories may also be used individually or in combination for storing data that is manipulated by the one or more baseband units 1404 when executing software. The one or more baseband units 1404 individually or in combination further include a reception component 1430, a communication manager 1432, and a transmission component 1434. The communication manager 1432 includes the one or more illustrated components. The components within the communication manager 1432 may be stored in the computer-readable medium/one or more memories and/or configured as hardware within the one or more baseband units 1404. The one or more baseband units 1404 may be components of the BS 310 and may individually or in combination include the one or more memories 376 and/or at least one of the one or more TX processors 316, at least one of the one or more RX processors 370, and at least one of the one or more controllers/processors 375. For example, the reception component 1430 may include at least the one or more RX processors 370, the transmission component 1434 may include at least the one or more TX processors 316, and the communication manager 1432 may include at least the one or more controllers/processors 375.

The communication manager 1432 includes a configuration component 1440 that is configured to send, for example via transmission component 1434, a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access, such as described in connection with block 1202. The communication manager 1432 may further include a reference signal component 1442 that is configured to send, for example via transmission component 1434, a downlink reference signal to a UE, such as described in connection with block 1204. The communication manager 1432 may further include a RACH message component 1444 that is configured to obtain from the UE, for example via reception component 1430, a RACH message associated with the downlink reference signal based on the one or more beam-specific RACH parameters, such as described in connection with block 1206.

The apparatus may include additional components that perform each of the blocks of the algorithm in the aforementioned flowchart of FIG. 12. As such, each block in the aforementioned flowcharts of FIG. 12 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1402, and in particular one or more baseband units 1404, includes means for sending a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access. The means for sending may be further configured to send a downlink reference signal to a UE. Moreover, the apparatus 1402, and in particular one or more baseband units 1404, includes means for obtaining from the UE a RACH message associated with the downlink reference signal based on the one or more beam-specific RACH parameters.

The aforementioned means may be one or more of the aforementioned components of the apparatus 1402 configured to perform the functions recited by the aforementioned means. As described supra, the apparatus 1402 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain a configuration including one or more beam-specific RAC) parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access; obtain a downlink reference signal from a network entity; and send to the network entity a RACH message associated with the downlink reference signal based on the one or more beam-specific RACH parameters.

Clause 2. The apparatus of clause 1, wherein the one or more beam-specific RACH parameters include the plurality of SSB RSRP thresholds, the downlink reference signal is the single SSB, and the RACH message is sent based on the plurality of SSB RSRP thresholds.

Clause 3. The apparatus of clause 2, wherein the configuration is a SIB including the plurality of SSB RSRP thresholds.

Clause 4. The apparatus of clause 2 or clause 3, wherein the RACH message is sent according to a number of repetitions based on a measured RSRP of the single SSB compared to the plurality of SSB RSRP thresholds.

Clause 5. The apparatus of any of clauses 2 to 4, wherein SSBs including the single SSB that are respectively associated with different transmission beams are associated with a same number of SSB RSRP thresholds or of RACH preamble repetitions.

Clause 6. The apparatus of any of clauses 2 to 4, wherein the configuration indicates different numbers of SSB RSRP thresholds or of RACH preamble repetitions for SSBs including the single SSB that are respectively associated with different transmission beams.

Clause 7. The apparatus of any of clauses 1 to 6, wherein the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter.

Clause 8. The apparatus of clause 7, wherein the two-step RACH parameter is a bitmap associated with a plurality of SSBs including the specific SSB, or a set of identifiers respectively associated with the SSBs, indicating whether two-step random access is enabled in association with respective ones of the SSBs.

Clause 9. The apparatus of clause 7 or 8, wherein the one or more beam-specific RACH parameters further include a PUSCH resource for two-step random access, and the PUSCH transmission is sent in the PUSCH resource.

Clause 10. The apparatus of any of clauses 1 to 9, wherein the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold.

Clause 11. The apparatus of any of clauses 1 to 10, wherein the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold.

Clause 12. The apparatus of clause 11, wherein the RSRP threshold is configured such that two-step random access is only enabled or only disabled in association with the downlink reference signal.

Clause 13. The apparatus of any of clauses 1 to 12, wherein the one or more beam-specific RACH parameters include the PUSCH RSRP threshold, and the RACH message includes a repetition of a PUSCH transmission based on the PUSCH RSRP threshold.

Clause 14. The apparatus of any of clauses 1 to 13, wherein the one or more beam-specific RACH parameters include the SUL RSRP threshold, and the RACH message is sent in the SUL carrier or the NUL carrier based on the SUL RSRP threshold.

Clause 15. The apparatus of any of clauses 1 to 14, wherein the one or more beam-specific RACH parameters include the CSI-RS RSRP threshold, the downlink reference signal is the CSI-RS, and the RACH message includes a RACH preamble associated with the CSI-RS based on the CSI-RS RSRP threshold.

Clause 16. The apparatus of clause 15, wherein the configuration indicates a plurality of CSI-RS resources including a CSI-RS resource associated with the CSI-RS, and the configuration further indicates a plurality of CSI-RS RSRP thresholds including the CSI-RS RSRP threshold which are respectively associated with the plurality of CSI-RS resources.

Clause 17. The apparatus of any of clauses 1 to 16, wherein the RACH message is sent in an RO mapped to an SSB index associated with the downlink reference signal based on the one or more beam-specific RACH parameters.

Clause 18. A method of wireless communication performable at a UE, comprising: obtaining a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access; obtaining a downlink reference signal from a network entity; and sending to the network entity a RACH message associated with the downlink reference signal based on the one or more beam-specific RACH parameters.

Clause 19. An apparatus for wireless communication, comprising: one or more memories; and one or more processors each communicatively coupled with at least one of the one or more memories, the one or more processors, individually or in any combination, operable to cause the apparatus to: send a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access; send a downlink reference signal to a UE; and obtain from the UE a RACH message associated with the downlink reference signal based on the one or more beam-specific RACH parameters.

Clause 20. The apparatus of clause 19, wherein the one or more beam-specific RACH parameters include the plurality of SSB RSRP thresholds, the configuration is a SIB including the plurality of SSB RSRP thresholds, the downlink reference signal is the single SSB, and the RACH message is obtained based on the plurality of SSB RSRP thresholds.

Clause 21. The apparatus of clause 20, wherein the RACH message is obtained according to a number of repetitions based on a measured RSRP of the single SSB compared to the plurality of SSB RSRP thresholds.

Clause 22. The apparatus of any of clauses 19 to 21, wherein the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter.

Clause 23. The apparatus of any of clauses 19 to 22, wherein the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold.

Clause 24. The apparatus of any of clauses 19 to 23, wherein the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold.

Clause 25. The apparatus of clause 24, wherein the RSRP threshold is configured such that two-step random access is only enabled or only disabled in association with the downlink reference signal.

Clause 26. The apparatus of any of clauses 19 to 25, wherein the one or more beam-specific RACH parameters include the PUSCH RSRP threshold, and the RACH message includes a repetition of a PUSCH transmission based on the PUSCH RSRP threshold.

Clause 27. The apparatus of any of clauses 19 to 26, wherein the one or more beam-specific RACH parameters include the SUL RSRP threshold, and the RACH message is obtained in the SUL carrier or the NUL carrier based on the SUL RSRP threshold.

Clause 28. The apparatus of any of clauses 19 to 27, wherein the one or more beam-specific RACH parameters include the CSI-RS RSRP threshold, the downlink reference signal is the CSI-RS, and the RACH message includes a RACH preamble associated with the CSI-RS based on the CSI-RS RSRP threshold.

Clause 29. The apparatus of any of clauses 19 to 28, wherein the RACH message is obtained in an RO mapped to an SSB index associated with the downlink reference signal based on the one or more beam-specific RACH parameters.

Clause 30. A method of wireless communication performable at a network entity, comprising: sending a configuration including one or more beam-specific RACH parameters, the one or more beam-specific RACH parameters including at least one of: a plurality of SSB RSRP thresholds for selection of a single SSB for four-step random access, a two-step RACH parameter indicating whether two-step random access is enabled in association with a specific SSB, a two-step RACH threshold for selection of an SSB for two-step random access or for selection between two-step random access and four-step random access, a PUSCH RSRP threshold for PUSCH transmission repetitions in four-step random access, a SUL RSRP threshold for selection between a NUL carrier and a SUL carrier for random access, or a CSI-RS RSRP threshold for selection of a CSI-RS for four-step random access; sending a downlink reference signal to a UE; and obtaining from the UE a RACH message associated with the downlink reference signal based on the one or more beam-specific RACH parameters.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain a configuration including one or more beam-specific random access channel (RACH) parameters, the one or more beam-specific RACH parameters including at least one of:
a plurality of synchronization signal block (SSB) reference signal received power (RSRP) thresholds for selection of a single SSB for four-step random access,
a two-step RACH parameter indicating whether two-step random access is enabled in association with a specific SSB,
a two-step RACH threshold for selection of an SSB for two-step random access or for selection between two-step random access and four-step random access,
a physical uplink shared channel (PUSCH) RSRP threshold for PUSCH transmission repetitions in four-step random access,
a supplementary uplink (SUL) RSRP threshold for selection between a normal uplink (NUL) carrier and a SUL carrier for random access, or
a channel state information reference signal (CSI-RS) RSRP threshold for selection of a CSI-RS for four-step random access;
obtain a downlink reference signal from a network entity; and
send to the network entity a RACH message associated with the downlink reference signal based on the one or more beam-specific RACH parameters.

2. The apparatus of claim 1, wherein the one or more beam-specific RACH parameters include the plurality of SSB RSRP thresholds, the downlink reference signal is the single SSB, and the RACH message is sent based on the plurality of SSB RSRP thresholds.

3. The apparatus of claim 2, wherein the configuration is a system information block (SIB) including the plurality of SSB RSRP thresholds.

4. The apparatus of claim 2, wherein the RACH message is sent according to a number of repetitions based on a measured RSRP of the single SSB compared to the plurality of SSB RSRP thresholds.

5. The apparatus of claim 2, wherein SSBs including the single SSB that are respectively associated with different transmission beams are associated with a same number of SSB RSRP thresholds or of RACH preamble repetitions.

6. The apparatus of claim 2, wherein the configuration indicates different numbers of SSB RSRP thresholds or of RACH preamble repetitions for SSBs including the single SSB that are respectively associated with different transmission beams.

7. The apparatus of claim 1, wherein the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter.

8. The apparatus of claim 7, wherein the two-step RACH parameter is a bitmap associated with a plurality of SSBs including the specific SSB, or a set of identifiers respectively associated with the SSBs, indicating whether two-step random access is enabled in association with respective ones of the SSBs.

9. The apparatus of claim 7, wherein the one or more beam-specific RACH parameters further include a PUSCH resource for two-step random access, and the PUSCH transmission is sent in the PUSCH resource.

10. The apparatus of claim 1, wherein the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold.

11. The apparatus of claim 1, wherein the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold.

12. The apparatus of claim 11, wherein the RSRP threshold is configured such that two-step random access is only enabled or only disabled in association with the downlink reference signal.

13. The apparatus of claim 1, wherein the one or more beam-specific RACH parameters include the PUSCH RSRP threshold, and the RACH message includes a repetition of a PUSCH transmission based on the PUSCH RSRP threshold.

14. The apparatus of claim 1, wherein the one or more beam-specific RACH parameters include the SUL RSRP threshold, and the RACH message is sent in the SUL carrier or the NUL carrier based on the SUL RSRP threshold.

15. The apparatus of claim 1, wherein the one or more beam-specific RACH parameters include the CSI-RS RSRP threshold, the downlink reference signal is the CSI-RS, and the RACH message includes a RACH preamble associated with the CSI-RS based on the CSI-RS RSRP threshold.

16. The apparatus of claim 15, wherein the configuration indicates a plurality of CSI-RS resources including a CSI-RS resource associated with the CSI-RS, and the configuration further indicates a plurality of CSI-RS RSRP thresholds including the CSI-RS RSRP threshold which are respectively associated with the plurality of CSI-RS resources.

17. The apparatus of claim 1, wherein the RACH message is sent in a RACH occasion (RO) mapped to an SSB index associated with the downlink reference signal based on the one or more beam-specific RACH parameters.

18. A method of wireless communication performable at a user equipment (UE), comprising:
obtaining a configuration including one or more beam-specific random access channel (RACH) parameters, the one or more beam-specific RACH parameters including at least one of:
a plurality of synchronization signal block (SSB) reference signal received power (RSRP) thresholds for selection of a single SSB for four-step random access,
a two-step RACH parameter indicating whether two-step random access is enabled in association with a specific SSB,
a two-step RACH threshold for selection of an SSB for two-step random access or for selection between two-step random access and four-step random access,
a physical uplink shared channel (PUSCH) RSRP threshold for PUSCH transmission repetitions in four-step random access,
a supplementary uplink (SUL) RSRP threshold for selection between a normal uplink (NUL) carrier and a SUL carrier for random access, or a channel state information reference signal (CSI-RS) RSRP threshold for selection of a CSI-RS for four-step random access;
obtaining a downlink reference signal from a network entity; and
sending to the network entity a RACH message associated with the downlink reference signal based on the one or more beam-specific RACH parameters.

19. An apparatus for wireless communication, comprising:
one or more memories; and
one or more processors each communicatively coupled with at least one of the one or more memories, the one or more processors, individually or in any combination, operable to cause the apparatus to:
send a configuration including one or more beam-specific random access channel (RACH) parameters, the one or more beam-specific RACH parameters including at least one of:
a plurality of synchronization signal block (SSB) reference signal received power (RSRP) thresholds for selection of a single SSB for four-step random access,
a two-step RACH parameter indicating whether two-step random access is enabled in association with a specific SSB,
a two-step RACH threshold for selection of an SSB for two-step random access or for selection between two-step random access and four-step random access,
a physical uplink shared channel (PUSCH) RSRP threshold for PUSCH transmission repetitions in four-step random access,
a supplementary uplink (SUL) RSRP threshold for selection between a normal uplink (NUL) carrier and a SUL carrier for random access, or
a channel state information reference signal (CSI-RS) RSRP threshold for selection of a CSI-RS for four-step random access;
send a downlink reference signal to a user equipment (UE); and
obtain from the UE a RACH message associated with the downlink reference signal based on the one or more beam-specific RACH parameters.

20. The apparatus of claim 19, wherein the one or more beam-specific RACH parameters include the plurality of SSB RSRP thresholds, the configuration is a system information block (SIB) including the plurality of SSB RSRP thresholds, the downlink reference signal is the single SSB, and the RACH message is obtained based on the plurality of SSB RSRP thresholds.

21. The apparatus of claim 20, wherein the RACH message is obtained according to a number of repetitions based on a measured RSRP of the single SSB compared to the plurality of SSB RSRP thresholds.

22. The apparatus of claim 19, wherein the one or more beam-specific RACH parameters include the two-step RACH parameter, the downlink reference signal is the specific SSB, the configuration is system information indicating the two-step RACH parameter, and the RACH message includes a combination of a RACH preamble and a PUSCH transmission based on the two-step RACH parameter.

23. The apparatus of claim 19, wherein the one or more beam-specific RACH parameters include the two-step RACH threshold, the two-step RACH threshold being a two-step SSB RSRP threshold for selection of the SSB for two-step random access, and the RACH message includes a RACH preamble associated with the SSB based on the two-step RACH threshold.

24. The apparatus of claim 19, wherein the one or more beam-specific RACH parameters include the two-step RACH threshold, the two-step RACH threshold being an RSRP threshold for selection between two-step random access and four-step random access, and the RACH message includes either a RACH preamble or a combination of the RACH preamble and a PUSCH transmission based on the RSRP threshold.

25. The apparatus of claim 24, wherein the RSRP threshold is configured such that two-step random access is only enabled or only disabled in association with the downlink reference signal.

26. The apparatus of claim 19, wherein the one or more beam-specific RACH parameters include the PUSCH RSRP threshold, and the RACH message includes a repetition of a PUSCH transmission based on the PUSCH RSRP threshold.

27. The apparatus of claim 19, wherein the one or more beam-specific RACH parameters include the SUL RSRP threshold, and the RACH message is obtained in the SUL carrier or the NUL carrier based on the SUL RSRP threshold.

28. The apparatus of claim 19, wherein the one or more beam-specific RACH parameters include the CSI-RS RSRP threshold, the downlink reference signal is the CSI-RS, and the RACH message includes a RACH preamble associated with the CSI-RS based on the CSI-RS RSRP threshold.

29. The apparatus of claim 19, wherein the RACH message is obtained in a RACH occasion (RO) mapped to an SSB index associated with the downlink reference signal based on the one or more beam-specific RACH parameters.

30. A method of wireless communication performable at a network entity, comprising:
sending a configuration including one or more beam-specific random access channel (RACH) parameters, the one or more beam-specific RACH parameters including at least one of:
a plurality of synchronization signal block (SSB) reference signal received power (RSRP) thresholds for selection of a single SSB for four-step random access,
a two-step RACH parameter indicating whether two-step random access is enabled in association with a specific SSB,
a two-step RACH threshold for selection of an SSB for two-step random access or for selection between two-step random access and four-step random access,
a physical uplink shared channel (PUSCH) RSRP threshold for PUSCH transmission repetitions in four-step random access,
a supplementary uplink (SUL) RSRP threshold for selection between a normal uplink (NUL) carrier and a SUL carrier for random access, or
a channel state information reference signal (CSI-RS) RSRP threshold for selection of a CSI-RS for four-step random access;
sending a downlink reference signal to a user equipment (UE); and
obtaining from the UE a RACH message associated with the downlink reference signal based on the one or more beam-specific RACH parameters.
